(19) United States
(12) Patent Application Publication
(10) Pub. No.: US 2021/0259039 A1
(43) Pub. Date: Aug. 19, 2021

(54) METHOD AND APPARATUS FOR HANDLING INVALID RRC RECONFIGURATION MESSAGE FOR SIDELINK COMMUNICATION IN A WIRELESS COMMUNICATION SYSTEM

(71) Applicant: ASUSTek Computer Inc., Taipei City (TW)

(72) Inventors: Li-Te Pan, Taipei City (TW); Richard Lee-Chee Kuo, Taipei City (TW)

(21) Appl. No.: 17/167,729

(22) Filed: Feb. 4, 2021

Related U.S. Application Data
(60) Provisional application No. 62/976,563, filed on Feb. 14, 2020.

(51) Int. Cl. H04W 76/27; H04W 28/02; H04W 76/30; H04W 4/40; H04W 80/02

(52) U.S. Cl. CPC H04W 76/27; H04W 28/0268; H04W 80/02; H04W 76/30; H04W 4/40; H04W 28/0263

(57) ABSTRACT

Methods and apparatuses for handling invalid Radio Resource Control (RRC) message for sidelink communication in a wireless communication system are disclosed herein. In one method, the first User Equipment (UE) establishes a PC5 unicast link or a PC5-RRC connection with a second UE, wherein the PC5 unicast link or the PC5-RRC connection is associated with a destination identity of the second UE. The first UE transmits a Sidelink User Equipment (UE) Information message to a network node to request a sidelink configuration for a sidelink Quality of Service (QoS) flow, wherein the Sidelink UE Information message includes the destination identity of the second UE and an identity of the sidelink QoS flow. The first UE receives a RRC Reconfiguration message from the network node, wherein the RRC Reconfiguration message includes the sidelink configuration. The first UE transmits a RRC message to the network node to indicate a configuration failure if the first UE is unable to comply with the sidelink configuration included in the RRC Reconfiguration message.

### CROSS-REFERENCE TO RELATED APPLICATIONS

The present application claims the benefit of U.S. Provisional Patent Application Ser. No. 62/976,563 filed on Feb. 14, 2020, the entire disclosure of which is incorporated herein in its entirety by reference.

### FIELD

This disclosure generally relates to wireless communication networks, and more particularly, to a method and apparatus for handling invalid Radio Resource Control (RRC) message for sidelink communication in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods and apparatuses for handling device-to-device feedback transmission in a wireless communication system are disclosed herein. In one method, the first User Equipment (UE) establishes a PC5 unicast link (or a PC5-RRC connection) with a second UE, wherein the PC5 unicast link (or the PC5-RRC connection) is associated with a destination identity of the second UE. The first UE transmits a Sidelink User Equipment (UE) Information message to a network node to request a sidelink configuration for a sidelink Quality of Service (QoS) flow, wherein the Sidelink UE Information message includes the destination identity of the second UE and an identity of the sidelink QoS flow. The first UE receives a RRC Reconfiguration message from the network node, wherein the RRC Reconfiguration message includes the sidelink configuration. The first UE transmits a RRC message to the network node to indicate a configuration failure if the first UE is unable to comply with the sidelink configuration included in the RRC Reconfiguration message.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 5.2.1.4-1 entitled “Example of PC5 Unicast Links” taken from 3GPP TS23.287 v16.0.0.

FIG. 6 is a reproduction of FIG. 6.3.3.1-1 entitled “Layer-2 link establishment procedure” taken from 3GPP TS23.287 v16.0.0.

FIG. 7 is a reproduction of FIG. 6.3.3.3-1 entitled “Layer-2 link release procedure” taken from 3GPP TS23.287 v16.0.0.

FIG. 8 is a reproduction of FIG. 6.3.3.4-1 entitled “Layer-2 link modification procedure” taken from 3GPP TS23.287 v16.0.0.

FIG. 9 is a reproduction of FIG. 7-1 entitled “SLRB configuration for SL unicast (UE-specific)” taken from 3GPP TS38.885-g00.

FIG. 10 is a reproduction of a Table entitled “SL-ConfigDedicatedNR field descriptions” taken from 3GPP email discussion [108#44][V2X] 38.331 running CR.

FIG. 11 is a reproduction of a Table entitled “SL-RadioBearerCoonfig field descriptions” taken from 3GPP email discussion [108#44][V2X] 38.331 running CR.

FIG. 12 is a reproduction of a Table describing “Conditional Presence” taken from 3GPP email discussion [108#44][V2X] 38.331 running CR.

FIG. 13 is a reproduction of a Table entitled “SDAP-Config field descriptions” taken from 3GPP email discussion [108#44][V2X] 38.331 running CR.

FIG. 14 is a reproduction of a Table entitled “SL-QoS-InfoConfig field descriptions” taken from 3GPP email discussion [108#44][V2X] 38.331 running CR.

FIG. 15 is a reproduction of FIG. 5.X.3.1-1 entitled “Sidelink UE information for NR sidelink communication” taken from 3GPP email discussion [108#44][V2X] 38.331 running CR.

FIG. 16 is a reproduction of a Table entitled “SidelinkUEinformationNR field descriptions” taken from 3GPP email discussion [108#44][V2X] 38.331 running CR.

FIG. 17 is a reproduction of a Table entitled “SL-TxResourceReq field descriptions” taken from 3GPP email discussion [108#44][V2X] 38.331 running CR.

FIG. 18 is a reproduction of FIG. 5.x.9.1.1-1 entitled “Sidelink RRC reconfiguration, successful” taken from 3GPP email discussion [108#44][V2X] 38.331 running CR.

FIG. 19 is a reproduction of FIG. 5.x.9.1.1-2 entitled “Sidelink RRC reconfiguration, failure” taken from 3GPP email discussion [108#44][V2X] 38.331 running CR.

FIG. 20 is a reproduction of a Table entitled “RRCReconfigurationSidelink field descriptions” taken from 3GPP email discussion [108#44][V2X] 38.331 running CR.

FIG. 21 is a flow diagram for one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems devices described below may be designed to support one or more standards such as the standard offered by a consortium named “3rd Generation Partnership Project” referred to herein as 3GPP, including: TS 23.287 v16.0.0, “Architecture enhancements for 5G System (5GS) to support Vehicle-to-Everything (V2X) services”; TR 38.885-g00, “NR; Study on NR Vehicle-to-Everything (V2X)”; R2-1908107, “Report from session on LTE V2X and NR V2X”; R2-1916288, “Report from session on LTE V2X and NR V2X”; email discussion [108#44][V2X] 38.331 running CR (Huawei), draft_R2-191xxx_Running CR to TS 38.331 for 5G V2X with NR Sidelink_v1; TS 38.331-f40, “NR RRC protocol specification”; and R2-1912001, “Report from session on LTE V2X and NR V2X”. The standards and documents listed above are hereby expressly incorporated by reference in their entirety.

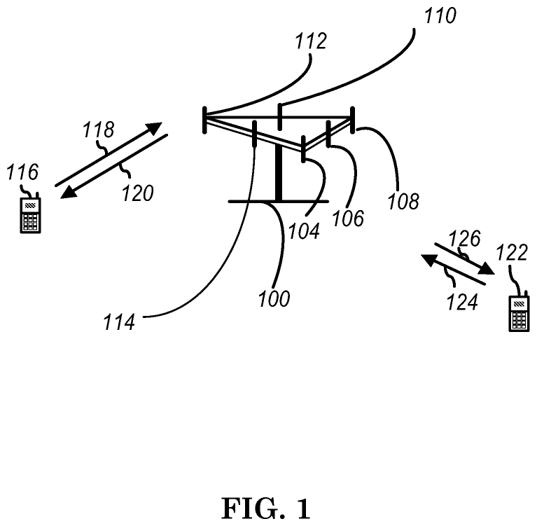

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

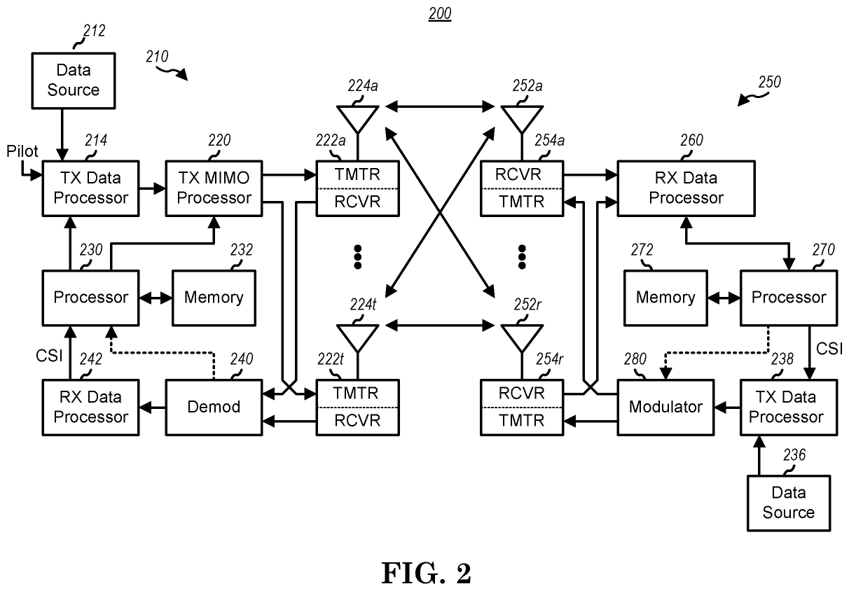

FIG. 2 is a simplified block diagram of an embodiment of a transmitter system 210 (also known as the access network) and a receiver system 250 (also known as access terminal (AT) or user equipment (UE) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and down converts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

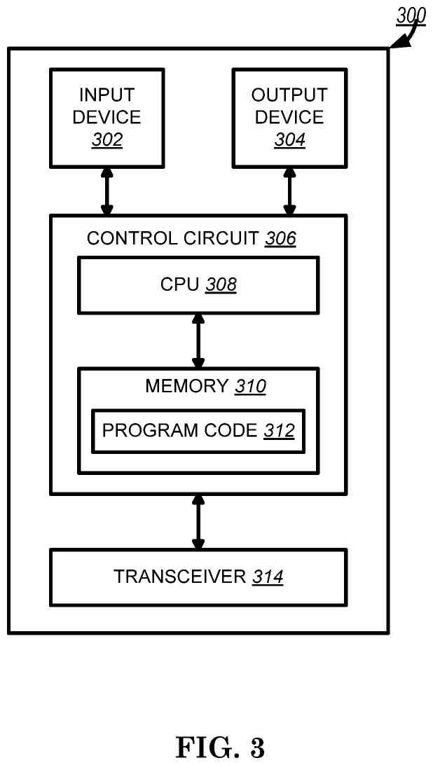

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is Alternatively the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

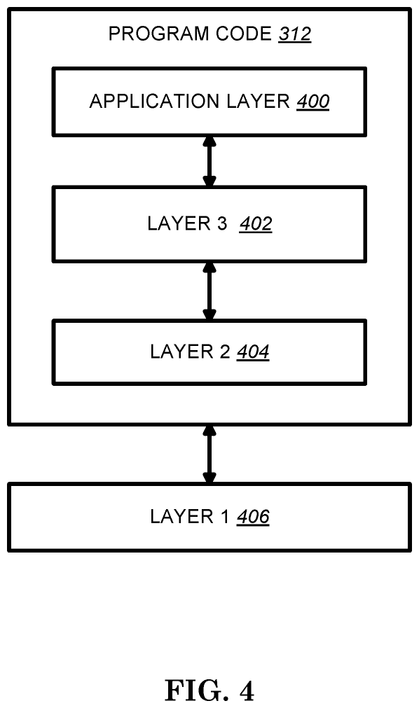

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS23.287 specifies V2X communication related to unicast mode as following:

### 5.1.2 Authorization and Provisioning for V2X Communications Over PC5 Reference Point

### 5.1.2.1 Policy/Parameter Provisioning

The following information for V2X communications over PC5 reference point is provisioned to the UE:

1) Authorization Policy:
When the UE is “served by E-UTRA” or “served by NR”:
   PLMNs in which the UE is authorized to perform V2X communications over PC5 reference point when “served by E-UTRA” or “served by NR”.
   For each above PLMN:
      RAT(s) over which the UE is authorized to perform V2X communications over PC5 reference point.
When the UE is “not served by E-UTRA” and “not served by NR”:
   Indicates whether the UE is authorized to perform V2X communications over PC5 reference point when “not served by E-UTRA” and “not served by NR”.
   RAT(s) over which the UE is authorized to perform V2X communications over PC5 reference point.

2) Radio Parameters when the UE is “not Served by E-UTRA” and “not Served by NR”:
Includes the radio parameters per PC5 RAT (i.e. LTE PC5, NR PC5) with Geographical Area(s) and an indication of whether they are “operator managed” or “non-operator managed”. The UE uses the radio parameters to perform V2X communications over PC5 reference point when “not served by E-UTRA” and “not served by NR” only if the UE can reliably locate itself in the corresponding Geographical Area. Otherwise, the UE is not authorized to transmit.
Editor's note: The radio parameters (e.g. frequency bands) are to be defined by RAN WGs. The reference to RAN specification will be added when defined in RAN WGs.
NOTE 1: Whether a frequency band is “operator managed” or “non-operator managed” in a given Geographical Area is defined by local regulations.

3) Policy/Parameters Per RAT for PC5 Tx Profile Selection:
The mapping of service types (e.g. PSIDs or ITS-AIDs) to Tx Profiles.

Editor's note: The Tx Profiles are to be defined by RAN WGs. The reference to RAN specification will be added when defined in RAN WGs.
4) Policy/parameters related to privacy:
The list of V2X services, e.g. PSIDs or ITS-AIDs of the V2X applications, with Geographical Area(s) that require privacy support.

5) Policy/Parameters when LTE PC5 is Selected:
Same as specified in TS 23.285 [8] clause 4.4.1.1.2 item 3) Policy/parameters except for the mapping of service types to Tx Profiles and the list of V2X services with Geographical Area(s) that require privacy support.

6) Policy/Parameters when NR PC5 is Selected:
The mapping of service types (e.g. PSIDs or ITS-AIDs) to V2X frequencies with Geographical Area(s).
The mapping of Destination Layer-2 ID(s) and the V2X services, e.g. PSIDs or ITS-AIDs of the V2X application for broadcast.
The mapping of Destination Layer-2 ID(s) and the V2X services, e.g. PSIDs or ITS-AIDs of the V2X application for groupcast.
The mapping of default Destination Layer-2 ID(s) for initial signalling to establish unicast connection and the V2X services, e.g. PSIDs or ITS-AIDs of the V2X application.
NOTE 2: The same default Destination Layer-2 ID for unicast initial signalling can be mapped to more than one V2X services. In the case where different V2X services are mapped to distinct default Destination Layer-2 IDs, when the UE intends to establish a single unicast link that can be used for more than one V2X services, the UE can select any of the default Destination Layer-2 IDs to use for the initial signalling.
PC5 QoS mapping configuration:
   Input from V2X application layer:
      V2X service (e.g. PSID or ITS-AID).
      (Optional) V2X Application Requirements for the V2X service, e.g. priority requirement, reliability requirement, delay requirement, range requirement.
NOTE 3: Details of V2X Application Requirements for the V2X service is up to implementation and out of scope of this specification.
   Output:
      PC5 QoS parameters defined in clause 5.4.2 (i.e. PQI and conditionally other parameters such as MFBR/GFBR, etc).
SLRB configurations, i.e. the mapping of PC5 QoS profile(s) to SLRB(s), when the UE is “not served by E-UTRA” and “not served by NR”.
   The PC5 QoS profile contains PC5 QoS parameters described in clause 5.4.2, and value for the QoS characteristics regarding Priority Level, Averaging Window, Maximum Data Burst Volume if default value is not used as defined in Table 5.4.4-1.
Editor's note: The SLRB configurations will be determined by RAN WGs. The reference to RAN specification will be added when defined in RAN WGs.
Editor's note: For the PC5 QoS profile, coordination with RAN WGs is needed.
Editor's note: The V2X frequencies with Geographical Area(s) will be determined by RAN WGs. The reference to RAN specification will be added when defined in RAN WGs.

### 5.2.1.4 Unicast Mode Communication Over PC5 Reference Point

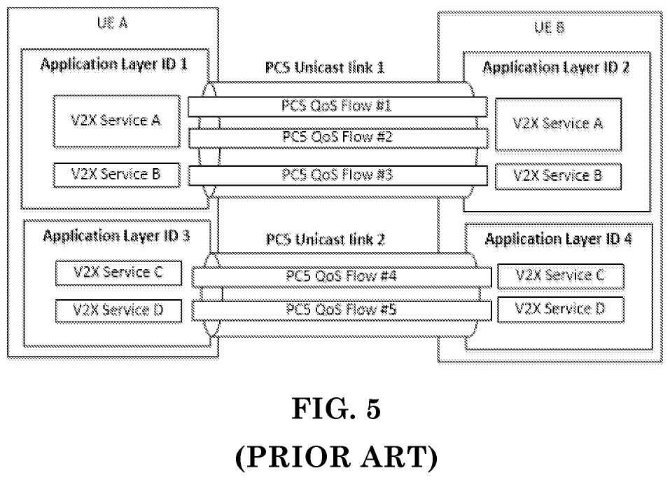

Unicast mode of communication is only supported over NR based PC5 reference point. FIG. 5.2.1.4-1 illustrates an example of PC5 unicast links.
FIG. 5.2.1.4-1 is reproduced as FIG. 5.
The following principles apply when the V2X communication is carried over PC5 unicast link:
A PC5 unicast link between two UEs allows V2X communication between one or more pairs of peer V2X services in these UEs. All V2X services in the UE using the same PC5 unicast link use the same Application Layer ID.
NOTE 1: An Application Layer ID may change in time as described in clauses 5.6.1.1 and 6.3.3.2, due to privacy. This does not cause a re-establishment of a PC5 unicast link.
One PC5 unicast link supports one or more V2X services (e.g. PSIDs or ITS-AIDs) if these V2X services are at least associated with the pair of peer Application Layer IDs for this PC5 unicast link. For example, as illustrated in FIG. 5.2.1.4-1, UE A and UE B have two PC5 unicast links, one between peer Application Layer ID 1/UE A and Application Layer ID 2/UE B and one between peer Application Layer ID 3/UE A and Application Layer ID 4/UE B.
NOTE 2: A source UE is not required to know whether different target Application Layer IDs over different PC5 unicast links belong to the same target UE.
A PC5 unicast link supports V2X communication using a single network layer protocol e.g. IP or non-IP.
A PC5 unicast link supports per-flow QoS model as specified in clause 5.4.1.
   When the Application layer in the UE initiates data transfer for a V2X service which requires unicast mode of communication over PC5 reference point:
the UE shall reuse an existing PC5 unicast link if the pair of peer Application Layer IDs and the network layer protocol of this PC5 unicast link are identical to those required by the application layer in the UE for this V2X service, and modify the existing PC5 unicast link to add this V2X service as specified in clause 6.3.3.4; otherwise
the UE shall trigger the establishment of anew PC5 unicast link as specified in clause 6.3.3.1.
   After successful PC5 unicast link establishment, UE A and UE B use the same pair of Layer-2 IDs for subsequent PC5-S signalling message exchange and V2X service data transmission as specified in clause 5.6.1.4. The V2X layer of the transmitting UE indicates to the AS layer whether a transmission is for a PC5-S signalling message (i.e. Direct Communication Request/Accept, Link Identifier Update Request/Response, Disconnect Request/Response, Link Modification Request/Accept) or V2X service data.
   For every PC5 unicast link, a UE self-assigns a distinct PC5 Link Identifier that uniquely identifies the PC5 unicast link in the UE for the lifetime of the PC5 unicast link. Each PC5 unicast link is associated with a Unicast Link Profile which includes:
service type(s) (e.g. PSID or ITS-AID), Application Layer ID and Layer-2 ID of UE A; and
Application Layer ID and Layer-2 ID of UE B; and
network layer protocol used on the PC5 unicast link; and
for each V2X service, a set of PC5 QoS Flow Identifier(s) (PFI(s)). Each PFI is associated with QoS parameters (i.e. PQI and optionally Range).
   For privacy reason, the Application Layer IDs and Layer-2 IDs may change as described in clauses 5.6.1.1 and 6.3.3.2 during the lifetime of the PC5 unicast link and, if so, shall be updated in the Unicast Link Profile accordingly. The UE uses PC5 Link Identifier to indicate the PC5 unicast link to V2X Application layer, therefore V2X Application layer identifies the corresponding PC5 unicast link even if there are more than one unicast link associated with one service type (e.g. the UE establishes multiple unicast links with multiple UEs for a same service type).
   The Unicast Link Profile shall be updated accordingly after a Layer-2 link modification for an established PC5 unicast link as specified in clause 6.3.3.4.

### 5.6 Identifiers

### 5.6.1 Identifiers for V2X Communication Over PC5 Reference Point

### 5.6.1.1 General

Each UE has one or more Layer-2 IDs for V2X communication over PC5 reference point, consisting of:
Source Layer-2 ID(s); and
Destination Layer-2 ID(s).
   Source and destination Layer-2 IDs are included in layer-2 frames sent on the layer-2 link of the PC5 reference point identifying the layer-2 source and destination of these frames. Source Layer-2 IDs are always self-assigned by the UE originating the corresponding layer-2 frames.
   The selection of the source and destination Layer-2 ID(s) by a UE depends on the communication mode of V2X communication over PC5 reference point for this layer-2 link, as described in clauses 5.6.1.2, 5.6.1.3, and 5.6.1.4. The source Layer-2 IDs may differ between different communication modes.
   When IP-based V2X communication is supported, the UE configures a link local IPv6 address to be used as the source IP address, as defined in clause 4.5.3 of TS 23.303 [17]. The UE may use this IP address for V2X communication over PC5 reference point without sending Neighbour Solicitation and Neighbour Advertisement message for Duplicate Address Detection.
   If the UE has an active V2X application that requires privacy support in the current Geographical Area, as identified by configuration described in clause 5.1.2.1, in order to ensure that a source UE (e.g. vehicle) cannot be tracked or identified by any other UEs (e.g. vehicles) beyond a certain short time-period required by the application, the source Layer-2 ID shall be changed over time and shall be randomized. For IP-based V2X communication over PC5 reference point, the source IP address shall also be changed over time and shall be randomized. The change of the identifiers of a source UE must be synchronized across layers used for PC5, e.g. when the Application Layer ID changes, the source Layer-2 ID and the source IP address need to be changed.

### 5.6.1.2 Identifiers for Broadcast Mode V2X Communication Over PC5 Reference Point

For broadcast mode of V2X communication over PC5 reference point, the UE is configured with the destination Layer-2 ID(s) to be used for V2X services. The destination Layer-2 ID for a V2X communication is selected based on the configuration as described in clause 5.1.2.1.
The UE self-selects a source Layer-2 ID. The UE may use different source Layer-2 IDs for different types of PC5 reference points, i.e. LTE based PC5 and NR based PC5.

### 5.6.1.3 Identifiers for Groupcast Mode V2X Communication Over PC5 Reference Point

For groupcast mode of V2X communication over PC5 reference point, the V2X application layer may provide group identifier information. When the group identifier information is provided by the V2X application layer, the UE converts the provided group identifier into a destination Layer-2 ID. When the group identifier information is not provided by the V2X application layer, the UE determines the destination Layer-2 ID based on configuration of the mapping between service type (e.g. PSID/ITS-AID) and Layer-2 ID, as specified in clause 5.1.2.1.
NOTE: The mechanism for converting the V2X application layer provided group identifier to the destination Layer-2 ID is defined in Stage 3.
   The UE self-selects a source Layer-2 ID.
Editor's note: Further updates of the identifiers description may be required based on RAN WG feedback.

### 5.6.1.4 Identifiers for Unicast Mode V2X Communication Over PC5 Reference Point

For unicast mode of V2X communication over PC5 reference point, the destination Layer-2 ID used depends on the communication peer, which is discovered during the establishment of the PC5 unicast link. The initial signalling for the establishment of the PC5 unicast link may use a default destination Layer-2 ID associated with the service type (e.g. PSID/ITS-AID) configured for PC5 unicast link establishment, as specified in clause 5.1.2.1. During the PC5 unicast link establishment procedure, Layer-2 IDs are exchanged, and should be used for future communication between the two UEs, as specified in clause 6.3.3.1.
The Application Layer ID is associated with one or more V2X applications within the UE. If UE has more than one Application Layer IDs, each Application Layer ID of the same UE may be seen as different UE's Application Layer ID from the peer UE's perspective.
The UE maintains a mapping between the Application Layer IDs and the source Layer-2 IDs used for the PC5 unicast links, as the V2X application layer does not use the Layer-2 IDs. This allows the change of source Layer-2 ID without interrupting the V2X applications.
When Application Layer IDs change, the source Layer-2 ID(s) of the PC5 unicast link(s) shall be changed if the link(s) was used for V2X communication with the changed Application Layer IDs.
A UE may establish multiple PC5 unicast links with a peer UE and use the same or different source Layer-2 IDs for these PC5 unicast links.
Editor's note: Further updates of the identifier description may be required based on RAN WG feedback.

### 6.3.3 Unicast Mode V2X Communication Over PC5 Reference Point

### 6.3.3.1 Layer-2 Link Establishment Over PC5 Reference Point

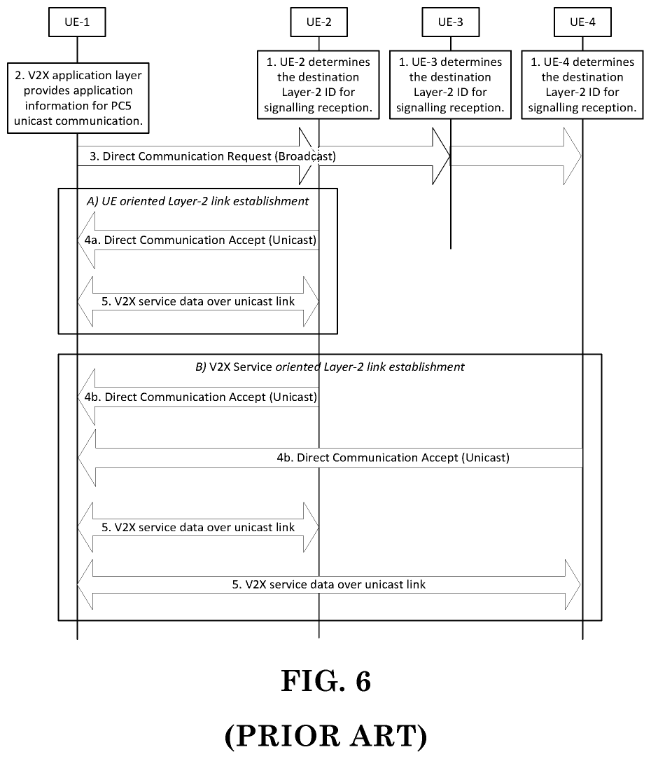

To perform unicast mode of V2X communication over PC5 reference point, the UE is configured with the related information as described in clause 5.1.2.1.
FIG. 6.3.3.1-1 shows the layer-2 link establishment procedure for unicast mode of V2X communication over PC5 reference point.
FIG. 6.3.3.1-1 is reproduced as FIG. 6.
1. The UE(s) determine the destination Layer-2 ID for signalling reception for PC5 unicast link establishment as specified in clause 5.6.1.4. The destination Layer-2 ID is configured with the UE(s) as specified in clause 5.1.2.1.
2. The V2X application layer in UE-1 provides application information for PC5 unicast communication. The application information includes the service type(s) (e.g. PSID or ITS-AID) of the V2X application and the initiating UE's Application Layer ID. The target UE's Application Layer ID may be included in the application information.
   The V2X application layer in UE-1 may provide V2X Application Requirements for this unicast communication. UE-1 determines the PC5 QoS parameters and PFI as specified in clause 5.4.1.4.
   If UE-1 decides to reuse the existing PC5 unicast link as specified in clause 5.2.1.4, the UE triggers Layer-2 link modification procedure as specified in clause 6.3.3.4.
3. UE-1 sends a Direct Communication Request message to initiate the unicast layer-2 link establishment procedure. The Direct Communication Request message includes:
   Source User Info: the initiating UE's Application Layer ID (i.e. UE-1's Application Layer ID).
   If the V2X application layer provided the target UE's Application Layer ID in step 2, the following information is included:
      Target User Info: the target UE's Application Layer ID (i.e. UE-2's Application Layer ID).
   V2X Service Info: the information about V2X Service(s) requesting Layer-2 link establishment (e.g. PSID(s) or ITS-AID(s)).
   Indication whether IP communication is used.
   IP Address Configuration: For IP communication, IP address configuration is required for this link and indicates one of the following values:
      “IPv6 Router” if IPv6 address allocation mechanism is supported by the initiating UE, i.e., acting as an IPv6 Router; or
      “IPv6 address allocation not supported” if IPv6 address allocation mechanism is not supported by the initiating UE.
   Link Local IPv6 Address: a link-local IPv6 address formed locally based on RFC 4862 [21] if UE-1 does not support the IPv6 IP address allocation mechanism, i.e. the IP Address Configuration indicates “IPv6 address allocation not supported”.
   QoS Info: the information about PC5 QoS Flow(s). For each PC5 QoS Flow, the PFI and the corresponding PC5 QoS parameters (i.e. PQI and conditionally other parameters such as MFBR/GFBR, etc).
   The source Layer-2 ID and destination Layer-2 ID used to send the Direct Communication Request message are determined as specified in clauses 5.6.1.1 and 5.6.1.4.
   UE-1 sends the Direct Communication Request message via PC5 broadcast using the source Layer-2 ID and the destination Layer-2 ID.
4. A Direct Communication Accept message is sent to UE-1 as below:
   4a. (UE oriented Layer-2 link establishment) If the Target User Info is included in the Direct Communication Request message, the target UE, i.e. UE-2 responds with a Direct Communication Accept message.
   4b. (V2X Service oriented Layer-2 link establishment) If the Target User Info is not included in the Direct Communication Request message, the UEs that are interested in using the announced V2X Service(s), so decide to establish Layer-2 link with UE-1 respond to the request by sending a Direct Communication Accept message (UE-2 and UE-4 in FIG. 6.3.3.1-1).
   The Direct Communication Accept message includes:
      Source User Info: Application Layer ID of the UE sending the Direct Communication Accept message.
      QoS Info: the information about PC5 QoS Flow(s). For each PC5 QoS Flow, the PFI and the corresponding PC5 QoS parameters requested by UE-1 (i.e. PQI and conditionally other parameters such as MFBR/GFBR, etc).
      IP Address Configuration: For IP communication, IP address configuration is required for this link and indicates one of the following values:
         “IPv6 Router” if IPv6 address allocation mechanism is supported by the target UE, i.e., acting as an IPv6 Router; or
         “IPv6 address allocation not supported” if IPv6 address allocation mechanism is not supported by the target UE.
      Link Local IPv6 Address: a link-local IPv6 address formed locally based on RFC 4862 [21] if the target UE does not support the IPv6 IP address allocation mechanism, i.e. the IP Address Configuration indicates “IPv6 address allocation not supported”, and UE-1 included a link-local IPv6 address in the Direct Communication Request message. The target UE shall include a non-conflicting link-local IPv6 address.
   If both UEs (i.e. the initiating UE and the target UE) selected to use link-local IPv6 address, they shall disable the duplicate address detection defined in RFC 4862 [21].
NOTE 1: When either the initiating UE or the target UE indicates the support of IPv6 router, corresponding address configuration procedure would be carried out after the establishment of the layer 2 link, and the link-local IPv6 addresses are ignored.
   The source Layer-2 ID used to send the Direct Communication Accept message is determined as specified in clauses 5.6.1.1 and 5.6.1.4. The destination Layer-2 ID is set to the source Layer-2 ID of the received Direct Communication Request message.
   Upon receiving the Direct Communication Accept message from peer UE, UE-1 obtains the peer UE's Layer-2 ID for future communication, for signalling and data traffic for this unicast link.
   The V2X layer of the UE that established PC5 unicast link passes the PC5 Link Identifier assigned for the unicast link and PC5 unicast link related information down to the AS layer. The PC5 unicast link related information includes Layer-2 ID information (i.e. source Layer-2 ID and destination Layer-2 ID). This enables the AS layer to maintain the PC5 Link Identifier together with the PC5 unicast link related information.
Editor's note: Steps for mutual authentication and security association establishment will be determined based on feedback from SA WG3.
5. V2X service data is transmitted over the established unicast link as below:
   The PC5 Link Identifier and PFI are provided to the AS layer, together with the V2X service data.
   UE-1 sends the V2X service data using the source Layer-2 ID (i.e. UE-1's Layer-2 ID for this unicast link) and the destination Layer-2 ID (i.e. the peer UE's Layer-2 ID for this unicast link).
NOTE 2: PC5 unicast link is bi-directional, therefore the peer UE of UE-1 can send the V2X service data to UE-1 over the unicast link with UE-1.
Editor's note: The parameters included in the Direct Communication Request/Accept messages can be updated depending on RAN WGs' decision on how the Direct Communication Request/Accept messages are sent by the AS layer (e.g. by using PC5-RRC signalling).
Editor's note: Additional parameters included in the Direct Communication Request/Accept messages (e.g. security related) are FFS.
Editor's note: Whether the unicast communication requires security protection at link layer will be determined based on feedback from SA WG3.
. . . .

### 6.3.3.3 Layer-2 Link Release Over PC5 Reference Point

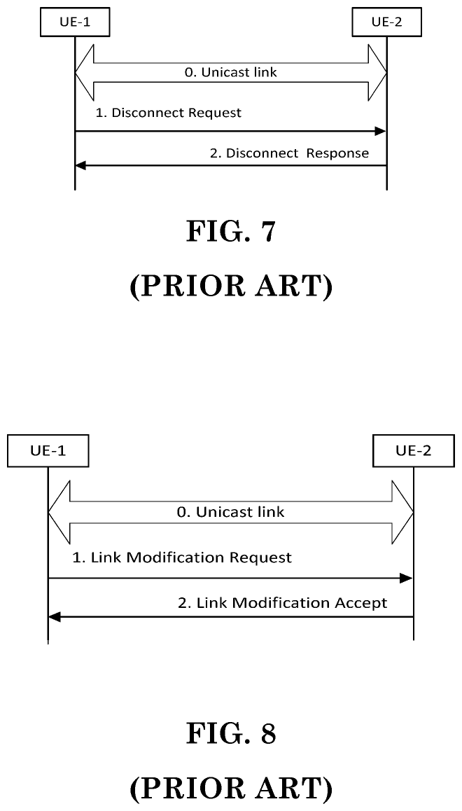

FIG. 6.3.3.3-1 shows the layer-2 link release procedure over PC5 reference point.
FIG. 6.3.3.3-1 is reproduced as FIG. 7.
0. UE-1 and UE-2 have a unicast link established as described in clause 6.3.3.1.
1. UE-1 sends a Disconnect Request message to UE-2 in order to release the layer-2 link and deletes all context data associated with the layer-2 link.
2. Upon reception of the Disconnect Request message UE-2 may respond with a Disconnect Response message and deletes all context data associated with the layer-2 link.
   The V2X layer of each UE informs the AS layer that the unicast link has been released. This enables the AS layer to delete the context related to the released unicast link.

### 6.3.3.4 Layer-2 Link Modification for a Unicast Link

FIG. 6.3.3.4-1 shows the layer-2 link modification procedure for a unicast link. This procedure is used to:
add new V2X service(s) to the existing PC5 unicast link.
remove any V2X service(s) from the the existing PC5 unicast link.
modify any PC5 QoS Flow(s) in the existing PC5 unicast link.
   FIG. 6.3.3.4-1 is reproduced as FIG. 8.
0. UE-1 and UE-2 have a unicast link established as described in clause 6.3.3.1.
1. The V2X application layer in UE-1 provides application information for PC5 unicast communication. The application information includes the service type(s) (e.g. PSID or ITS-AID) of the V2X application(s) and the initiating UE's Application Layer ID. The target UE's Application Layer ID may be included in the application information. If UE-1 decides to reuse the existing PC5 unicast link as specified in clause 5.2.1.4, so decides to modify the unicast link established with UE-2, UE-1 sends a Link Modification Request to UE-2.
   The Link Modification Request message includes:
      a) To add new V2X service(s) to the existing PC5 unicast link:
         V2X Service Info: the information about V2X Service(s) to be added (e.g. PSID(s) or ITS-AID(s)).
         QoS Info: the information about PC5 QoS Flow(s) for each V2X Service to be added. For each PC5 QoS Flow, the PFI and the corresponding PC5 QoS parameters (i.e. PQI and conditionally other parameters such as MFBR/GFBR, etc).
      b) To remove any V2X service(s) from the the existing PC5 unicast link:
         V2X Service Info: the information about V2X Service(s) to be removed (e.g. PSID(s) or ITS-AID(s)).
      c) To modify any PC5 QoS Flow(s) in the existing PC5 unicast link:
         QoS Info: the information about PC5 QoS Flow(s) to be modified. For each PC5 QoS Flow, the PFI and the corresponding PC5 QoS parameters (i.e. PQI and conditionally other parameters such as MFBR/GFBR, etc).
2. UE-2 responds with a Link Modification Accept message.
   The Link Modification Accept message includes:
      For case a) and case c) described in step 1:
         QoS Info: the information about PC5 QoS Flow(s). For each PC5 QoS Flow, the PFI and the corresponding PC5 QoS parameters (i.e. PQI and conditionally other parameters such as MFBR/GFBR, etc).
   The V2X layer of each UE provides information about the unicast link modification to the AS layer. This enables the AS layer to update the context related to the modified unicast link.

3GPP TS38.885-g00 specifies QoS management for NR V2X unicast mode communication as quoted below:

### 7 QoS Management

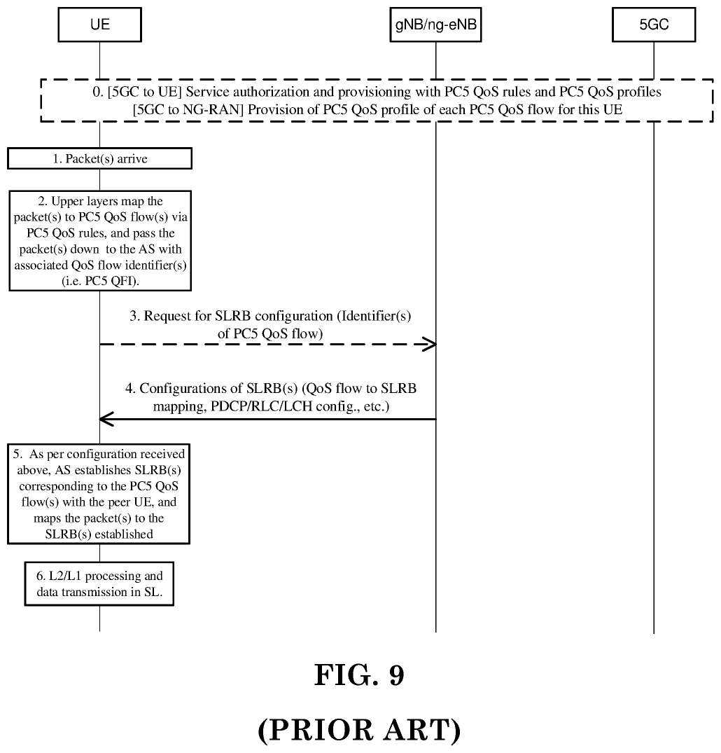

QoS management is relevant to V2X in the context of its use in resource allocation, congestion control, in-device coexistence, power control and SLRB configuration. Physical layer parameters related to QoS management are the priority, latency, reliability and minimum required communication range (as defined by higher layers) of the traffic being delivered. Data rate requirements are also supported in the AS. A SL congestion metric and, at least in resource allocation mode 2, mechanisms for congestion control are needed. It is beneficial to report the SL congestion metric to gNB.
For SL unicast, groupcast and broadcast, QoS parameters of V2X packets are provided by upper layers to the AS. For SL unicast, the SLRBs are (pre-)configured based on the signalling flows and procedures shown in FIGS. 7-1 and 7-2. The per-flow QoS model described in [6] is assumed in upper layers.
FIG. 7-1 is reproduced as FIG. 9.
In Step 0 of FIG. 7-1, the PC5 QoS profile, i.e. a set of specific PC5 QoS parameters, and PC5 QoS rule for each PC5 QoS flow are provisioned to the UE in advance by service authorization and provisioning procedures as in [6]; similarly, PC5 QoS profile for each QoS flow is also provisioned to the gNB/ng-eNB in advance. Then, when packet(s) arrive, the UE can first derive the identifier of the associated PC5 QoS flow(s) (i.e. PC5 QFI) based on the PC5 QoS rules configured in Step 0, and may then report the derived PC5 QFI(s) to the gNB/ng-eNB in Step 3. The gNB/ng-eNB can derive the QoS profile(s) of these reported PC5 QFI(s) based on the provisioning from 5GC in Step 0, and may signal the configurations of the SLRB(s) associated with the PC5 QFI(s) UE reported via RRC dedicated signalling in Step 4. These SLRB configurations may include PC5 QoS flow to SLRB mapping, SDAP/PDCP/RLC/LCH configurations, etc. In Step 5, the UE in the AS establishes SLRB(s) associated with the PC5 QFI(s) of the packet(s) with the peer UE as per gNB/ng-eNB configuration, and maps available packet(s) to the SLRB(s) established. SL unicast transmission can then occur.
NOTE: How the PC5 QFI is defined is up to SA2 WG2.

3GPP R2-1908107 captures RAN2#106 agreements on NR SL QoS and SLRB configurations as quoted below:

| | |
|---|---|
| 1: | Stick to SI phase conclusion that SLRB configurations should be NW-configured and/or pre- |
| | configured for NR SL. |
| 2: | For an RRC_CONNECTED UE, for transmission of a new PC5 QoS flow, it may report the QoS |
| | information of the PC5 QoS flow via RRC dedicated signalling to the gNB/ng-eNB. FFS on the |
| | exact timing about when UE initiates. |
| 3: | For an RRC_CONNECTED UE, the gNB/ng-eNB may provide SLRB configurations and configure |
| | the mapping of PC5 QoS flow to SLRB via RRC dedicated signalling, based on the QoS information |
| | reported by the UE. The UE can establishes/reconfigures the SLRB only after receiving the SLRB |
| | configuration. FFS when the UE establishes/reconfigures the SLRB. |
| 4: | FFS what the reported QoS information is (e.g. PFI, PC5 QoS profile, etc.) and what is used to |
| | realize the PC5 QoS flow to SLRB mapping (e.g. PFI to SLRB mapping, QoS profile to SLRB |
| | mapping, etc.), depending on SA2 conclusion on how PFI is assigned. |
| 5: | For RRC_IDLE/INACTIVE UEs, the gNB/ng-eNB may provide SLRB configurations and configure |
| | the PC5 QoS profile to SLRB mapping via V2X-specific SIB. When an RRC_IDLE/INACTIVE UE |
| | initiates the transmission of a new PC5 QoS flow, it establishes the SLRB associated with the PC5 |
| | QoS profile of that flow based on SIB configuration. |
| 6: | FFS how to describe each PC5 QoS profile in the SIB, pending SA2's final conclusion on what PC5 |
| | QoS parameters are included in a PC5 QoS profile. |
| 7: | For OoC UEs, SLRB configurations and the mapping of PC5 QoS profile to SLRB are pre- |
| | configured. When an OoC UE initiates the transmission of a new PC5 QoS flow, it establishes the |
| | SLRB associated with the flow based on pre-configuration. |
| 8: | FFS what is used to realize for PC5 QoS flow to SLRB mapping in pre-configuration (e.g. PFI to |
| | SLRB mapping, QoS profile to SLRB mapping, etc.), depending on SA2 conclusion on how PFI is |
| | assigned. |
| 9: | For SL unicast of a UE, the NW-configured/pre-configured SLRBs configurations include the SLRB |
| | parameters that are only related to TX, as well as the SLRB parameters that are related to both TX |
| | and RX and need to be aligned with the peer UEs. |
| 10: | For SL unicast, the initiating UE informs the peer UE of SLRB parameters that are related to both |
| | TX and RX and need to be aligned with the peer UEs. FFS on the detailed parameters. |
| 11: | For SL unicast, do not allow a UE to configure “SLRB parameters only related to TX” for the peer |
| | UE in SL via PC5 RRC message. FFS how to handle SRLB parameters only related to RX. |
| 12: | For SL groupcast and/or broadcast, the NW-configured/preconfigured SLRBs include the SLRB |
| | parameters that are only related to TX. |
| 13: | Those SLRB parameters which are related to both TX and RX and thus need to be aligned between a |
| | UE and all its peer UE(s) should be fixed in the Spec for SL groupcast and broadcast. |
| 14: | For SL broadcast, how to set SLRB parameters only related to RX is up to UE implementation. FFS |
| | for groupcast case. |
| 15: | SLRB configurations should be (pre-)configured for SL unicast, groupcast/broadcast separately. FFS |
| | on the need of separate SLRB configurations between groupcast and broadcast. |

3GPP R2-1912001 captures RAN2#107 agreements on SLRB configuration for e.g. TX-RX aligned sidelink parameters as quoted below:

Agreements on SLRB configuration:

| | |
|---|---|
| 1-1: | For SL unicast, SLRB Identity is both Tx and Rx parameter. For SL broadcast and groupcast, FFS on |
| | its Tx/Rx attribute, i.e. Tx only or both Tx and Rx. |
| 1-2: | For dedicated SLRB configuration, destination identity is one of the SLRB parameters for |
| | configuration. It is applicable to SL broadcast, groupcast and unicast. FFS on its Tx/Rx attribute. |
| 1-3: | Cast type is considered as one of the SLRB parameters for common configuration via |
| | SIB/preconfiguration. It is applicable to SL broadcast, groupcast and unicast. FFS on its Tx/Rx |
| | attribute. |
| 2-1: | Default SLRB configuration is applicable for each cast type. |
| 2-2: | The mapped QoS flow(s) to SLRB is considered as one of the SLRB parameters for configuration. It |
| | is applicable to SL broadcast, groupcast and unicast. For unicast it is applicable to both Tx and Rx, |
| | for groupcast and broadcast, it is applicable to only TX. |
| 2-3: | Transmission range to SLRB mapping is considered as one of the SLRB parameters for |
| | configuration. |
| 3-1: | Discard timer is Tx only parameter and applicable to SL broadcast, groupcast and unicast. |
| 3-2: | PDCP SN Size is both Tx and Rx parameter and applicable to SL broadcast, groupcast and unicast. |
| 3-3: | MaxCID is both Tx and Rx parameter and applicable to SL broadcast, groupcast and unicast. |
| 3-4: | ROHC profile needs to be configured for TX UE. |
| 3-5: | T-reordering timer is Rx only parameter and applicable to SL broadcast, groupcast and unicast. |
| 3-6: | OutOfOrderDelivery is Rx only parameter and applicable to SL unicast. FFS on SL broadcast, |
| | groupcast. FFS on TX case. |
| 4-1: | RLC mode is both Tx and Rx parameter and applicable to SL unicast. |
| 4-2: | RLC SN field length is both Tx and Rx parameter and applicable to SL broadcast, groupcast and |
| | unicast. |
| 4-3: | T-Reassembly timer is Rx only parameter and applicable to SL broadcast, groupcast and unicast. |
| 4-4: | T-PollRetransmit timer is Tx only parameter and applicable to SL unicast. |
| 4-5: | PollPDU is Tx only parameter and applicable to SL unicast. |
| 4-6: | PollByte is Tx only parameter and applicable to SL unicast. |
| 4-7: | MaxRetxThreshold is Tx only parameter and applicable to SL unicast. |
| 4-8: | T-StatusProhibit timer is Rx only parameter and applicable to SL unicast. |
| 5-1: | LogicalChannelldentity is both TX and RX parameter and applicable to SL unicast. It is only TX |
| | parameter to SL broadcast and groupcast. |
| 5-2: | LogicalChannelGroup is Tx only parameter and applicable to SL broadcast, groupcast and unicast. |
| 5-3: | Priority is Tx only parameter and applicable to SL broadcast, groupcast and unicast. |
| 5-4: | PrioritizedBitRate is Tx only parameter and applicable to SL broadcast, groupcast and unicast. |
| 5-5: | BucketSizeDuration is Tx only parameter and applicable to SL broadcast, groupcast and unicast. |
| 5-6: | ConfiguredGrantType1Allowed is Tx only parameter and applicable to SL broadcast, groupcast and |
| | unicast. |
| 5-7: | SchedulingRequestID is Tx only parameter and applicable to SL broadcast, groupcast and unicast. |
| 5-8: | LogicalChannelSR-DelayTimerApplied is Tx only parameter and applicable to SL broadcast, |
| | groupcast and unicast. |
| 5-9: | It is FFS whether any HARQ related information is considered as one of the SLRB parameters for |
| | configuration. |
| 6-1: | For SL groupcast, it is up to UE implementation on how to set the Rx only SLRB parameters. |
| 6-2: | For SL unicast, it is up to UE implementation on how to set the Rx only SLRB parameters. |
| 6-3: | Separate SLRB configuration is considered for SL broadcast and groupcast. |

3GPP R2-1916288 captures RAN2#108 agreements on RLC and LCID mismatch as quoted below:

| | |
|---|---|
| 1: | When the peer UE in RRC_CONNECTED receives an SLRB configuration with RLC AM/UM from |
| | the initiating UE via PC5 RRC and if the LCH has not been configured in the peer UE, it reports at |
| | least RLC mode by the initiating UE via PC5 RRC to its gNB. PC5 QoS profile is optional to be |
| | reported. |
| 2: | When the peer UE in RRC_CONNECTED receives an SLRB configuration with RLC AM/UM for a |
| | specific LCID via PC5 RRC from the initiating UE and if the LCH has not been configured in the |
| | peer UE, the peer UE autonomously determines to follow the usage of this LCID by the initiating UE, |
| | and assigns this LCID to a dedicated SLRB configuration with RLC AM requested from its gNB. |
| | (working assumption) |
| 3: | When the peer UE in RRC_IDLE/INACTIVE receives an SLRB configuration with RLC AM/UM |
| | for a specific LCID via PC5 RRC from the initiating UE and if the LCH has not been configured in |
| | the peer UE, the peer UE autonomously assigns this LCID value to the configured SLRB. Up to UE |
| | implementation to configure SRLB with the corresponding RLC mode by selecting existing SLRB |
| | configurations in SIB. |
| 4: | When the peer UE in OOC receives an SLRB configuration with RLC AM/UM for a specific LCID |
| | via PC5 RRC from the initiating UE and if the LCH has not been configured in the peer UE, the peer |
| | UE autonomously assigns this LCID value to the configured SLRB. Up to UE implementation to |
| | configure SRLB with the corresponding RLC mode by selecting existing SLRB configurations |
| | in preconfiguration. |
| 5: | LCID for NR sidelink communication is assigned by the UE. |
| 6: | If the LCH has been configured with the different RLC mode in the peer UE, UE handles that as AS- |
| | layer configuration failure. |
| 7: | TS38.331 will capture the agreements “Up to UE implementation to configure SRLB with the |
| | corresponding RLC mode by selecting existing SLRB configurations in SIB” in 3) and “Up to UE |
| | implementation to configure SRLB with the corresponding RLC mode by selecting existing SLRB |
| | configurations in Preconfiguration” in 4) as NOTE. |

3GPP discloses an updated running CR to TS 38.331 for capturing new 5G V2X with NR Sidelink agreements circulated on Dec. 26, 2019 specifies sidelink related procedures and messages for NR V2X as quoted below:

### 5.3.5 RRC Reconfiguration

### <Unrelated Texts Omitted>

### 5.3.5.3 Reception of an RRCReconfiguration by the UE

The UE shall perform the following actions upon reception of the RRCReconfiguration:
. . . .
1> if the RRCReconfiguration message includes the sl-ConfigDedicatedNR:
   2> perform the sidelink dedicated configuration procedure as specified in 5.3.5.X;
      . . . .
RRCReconfiguration
   The RRCReconfiguration message is the command to modify an RRC connection. It may convey information for measurement configuration, mobility control, radio resource configuration (including RBs, MAC main configuration and physical channel configuration) and AS security configuration.
Signalling radio bearer: SRB1 or SRB3
RLC-SAP: AM
Logical channel: DCCH
Direction: Network to UE

RRCReconfiguration message

-- ASN1START
-- TAG-RRCRECONFIGURATION-START
...

| | |
|---|---|
| RRCReconfiguration-v16xy-IEs ::= | SEQUENCE { |

| | |
|---|---|
| sl-ConfigDedicatedNR-r16 | SetupRelease {SL-ConfigDedicatedNR-r16} |

| | |
|---|---|
| OPTIONAL, | -- Need M |

| | |
|---|---|
| sl-ConfigDedicatedEUTRA-r16 | SetupRelease {SL-ConfigDedicatedEUTRA-r16} |

| | |
|---|---|
| OPTIONAL, | -- Need M |

| | |
|---|---|
| nonCriticalExtension | SEQUENCE { } |

OPTIONAL
}
-- TAG-RRCRECONFIGURATION-STOP
-- ASN1STOP

SL-ConfigDedicatedNR
   The IE SL-ConfigDedicatedNR specifies the dedicated configuration information for NR sidelink communication.

SL-ConfigDedicatedNR information element

-- ASN1START
-- TAG-SL-CONFIGDEDICATEDNR-START

| | |
|---|---|
| SL-ConfigDedicatedNR-r16 ::= | SEQUENCE { |

| | |
|---|---|
| sl-ScheduledConfig-r16 | SetupRelease { SL-ScheduledConfig-r16 } |

| | |
|---|---|
| OPTIONAL, | -- Need M |

| | |
|---|---|
| sl-UE-SelectedConfig-r16 | SetupRelease { SL-UE-SelectedConfig-r16 } |

| | |
|---|---|
| OPTIONAL, | -- Need M |

| | |
|---|---|
| sl-FreqInfoToReleaseList-r16 | SEQUENCE (SIZE (1..maxNrofFreqSL-r16)) OF ARFCN- |

| | | |
|---|---|---|
| ValueNR | OPTIONAL, | -- Need M |

| | |
|---|---|
| sl-FreqInfoToAddModList-r16 | SEQUENCE (SIZE (1..maxNrofFreqSL-r16)) OF SL- |

| | | |
|---|---|---|
| FreqConfig-r16 | OPTIONAL, | -- Need M |

-- Editor's Note: FFS on whether both mode-1 and mode-2 can be both configured.

| | |
|---|---|
| sl-RadioBearerToReleaseList-r16 | SEQUENCE (SIZE (1..maxNrofSLRB-r16)) OF SLRB-Uu- |

| | | |
|---|---|---|
| ConfigIndex-r16 | OPTIONAL, | -- Need N |

| | |
|---|---|
| sl-RadioBearerToAddModList-r16 | SEQUENCE (SIZE (1..maxNrofSLRB-r16)) OF SL- |

| | | |
|---|---|---|
| RadioBearerConfig-r16 | OPTIONAL, | -- Need N |

| | |
|---|---|
| sl-RLC-BearerToReleaseList-r16 | SEQUENCE (SIZE (1..maxSL-LCID-r16)) OF SL-RLC- |

| | | |
|---|---|---|
| BearerConfigIndex-r16 | OPTIONAL, | -- Need N |

| | |
|---|---|
| sl-RLC-BearerToAddModList-r16 | SEQUENCE (SIZE (1..maxSL-LCID-r16)) OF SL-RLC- |

| | | |
|---|---|---|
| BearerConfig-r16 | OPTIONAL, | -- Need N |

| | |
|---|---|
| sl-MeasConfigInfoToReleaseList-r16 | SEQUENCE (SIZE (1..maxNrofSL-Dest-r16)) OF SL- |

| | | |
|---|---|---|
| DestinationIndex-r16 | OPTIONAL, | -- Need N |

| | |
|---|---|
| sl-MeasConfigInfoToAddModList-r16 | SEQUENCE (SIZE (1..maxNrofSL-Dest-r16)) OF SL- |

| | | |
|---|---|---|
| MeasConfigInfo-r16 | OPTIONAL, | -- Need M |

| | |
|---|---|
| t400 | ENUMERATED {ms100, ms200, ms300, ms400, ms 600, |

| | | |
|---|---|---|
| ms1000, ms1500, ms2000} | OPTIONAL, | -- Need M |

| | |
|---|---|
| sl-CSI-Acquisition-r16 | ENUMERATED {enabled} |

| | |
|---|---|
| OPTIONAL, | -- Need N |

| | |
|---|---|
| sl-SSB-PriorityNR-r16 | INTEGER (1..8) |

| | |
|---|---|
| OPTIONAL, | -- Need N |

| | |
|---|---|
| sl-PUCCH-Config-r16 | PUCCH-Config |

| | |
|---|---|
| OPTIONAL, | -- Need N |

| | |
|---|---|
| sl-PDCCH-Config-r16 | PDCCH-Config |

| | |
|---|---|
| OPTIONAL, | -- Need N |

| | |
|---|---|
| networkControlledSyncTx-r16 | ENUMERATED {on, off} |

| | |
|---|---|
| OPTIONAL, | -- Need N |

...

}
-- TAG-SL-CONFIGDEDICATEDNR-STOP
-- ASN1STOP

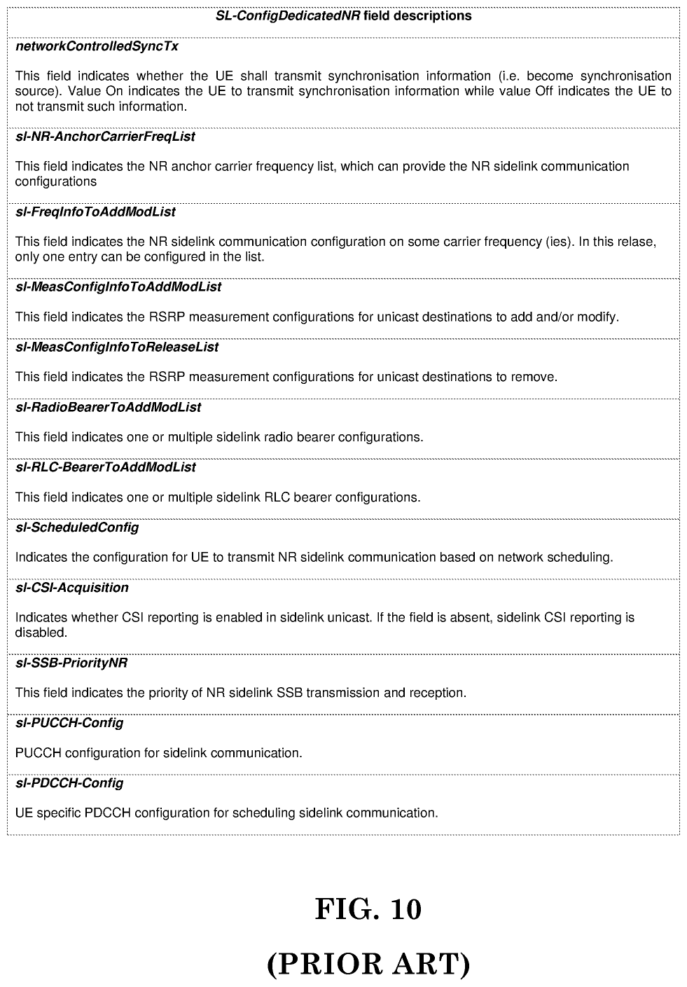

Table entitled “SL-ConfigDedicatedNR field descriptions” reproduced as FIG. 10.

### SL-RadioBearerConfig

The IE SL-RadioBearerConfig specifies the sidelink DRB configuration information for NR sidelink communication.

SL-RadioBearerConfig information element

-- ASN1START
-- TAG-SL-RADIOBEARERCONFIG-START

| | |
|---|---|
| SL-RadioBearerConfig-r16 ::= | SEQUENCE { |

| | |
|---|---|
| slrb-Uu-ConfigIndex-r16 | SLRB-Uu-ConfigIndex-r16, |
| sl-SDAP-Config-r16 | SL-SDAP-Config-r16 |

| | |
|---|---|
| OPTIONAL, | -- Cond SLRBSetup |

| | |
|---|---|
| sl-PDCP-Config-r16 | SL-PDCP-Config-r16 |

| | |
|---|---|
| OPTIONAL, | -- Cond SLRBSetup |

| | |
|---|---|
| sl-TransRange-r16 | ENUMERATED {m50, m80, m180, m200, |

m350,

m400, m500, m700, m1000}

| | |
|---|---|
| OPTIONAL, | -- Need M |

...

}
-- TAG-SL-RADIOBEARERCONFIG-STOP
-- ASN1STOP

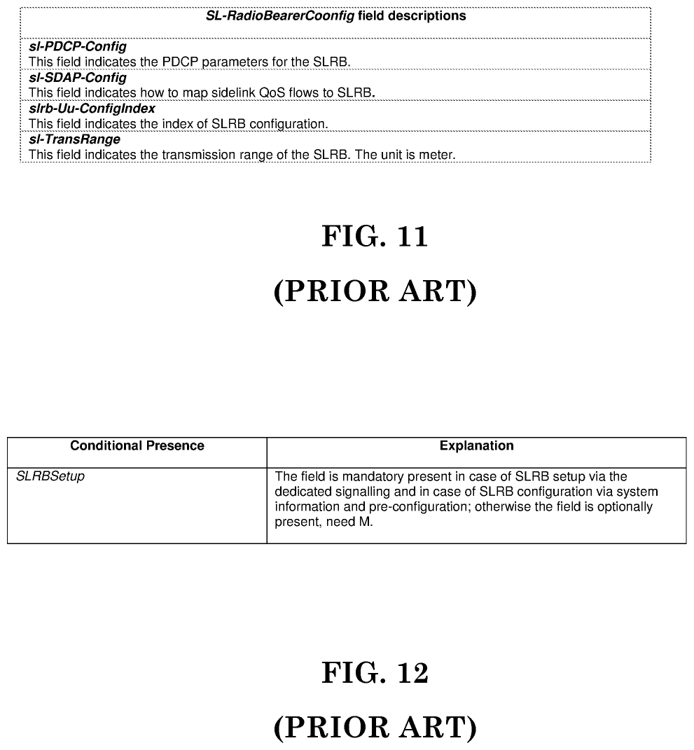

Table entitled “SL-RadioBearerCoonfig field descriptions” reproduced as FIG. 11.
Table describing “Conditional Presence” reproduced as FIG. 12.

### SL-SDAP-Config

The IE SL-SDAP-Config is used to set the configurable SDAP parameters for a Sidelink DRB.

SL-SDAP-Config information element

-- ASN1START
-- TAG-SL-SDAP-CONFIG-START

| | |
|---|---|
| SL-SDAP-Config-r16 ::= | SEQUENCE { |

| | |
|---|---|
| sl-SDAP-Header-r16 | ENUMERATED {present, absent}, |
| sl-DefaultRB-r16 | BOOLEAN, |
| sl-MappedQoS-Flows-r16 | CHOICE { |

| | |
|---|---|
| sl-MappedQoS-FlowsList-r16 | SEQUENCE (SIZE (1..maxNrofSL-QFIs-r16)) OF SL- |

QoS-Profile-r16,

| | |
|---|---|
| sl-MappedQoS-FlowsListDedicated-r16 | SL-MappedQoS-FlowsListDedicated-r16 |

}

| | |
|---|---|
| OPTIONAL, | -- Need M |

| | |
|---|---|
| sl-CastType-r16 | ENUMERATED {broadcast, groupcast, unicast, spare1} |

| | |
|---|---|
| OPTIONAL, | -- Need M |

...

}

| | |
|---|---|
| SL-MappedQoS-FlowsListDedicated-r16 r16 | SEQUENCE { |

| | |
|---|---|
| sl-MappedQoS-FlowsToAddList-r16 | SEQUENCE (SIZE (1..maxNrofSL-QFIs-r16)) OF SL-QoS- |

| | | |
|---|---|---|
| FlowIdentity-r16 | OPTIONAL, | -- Need N |

| | |
|---|---|
| sl-MappedQoS-FlowsToReleaseList-16 | SEQUENCE (SIZE (1..maxNrofSL-QFIs-r16)) OF SL-QoS- |

| | | |
|---|---|---|
| FlowIdentity-r16 | OPTIONAL | -- Need N |

}
-- TAG-SL-SDAP-CONFIG-STOP
-- ASN1STOP

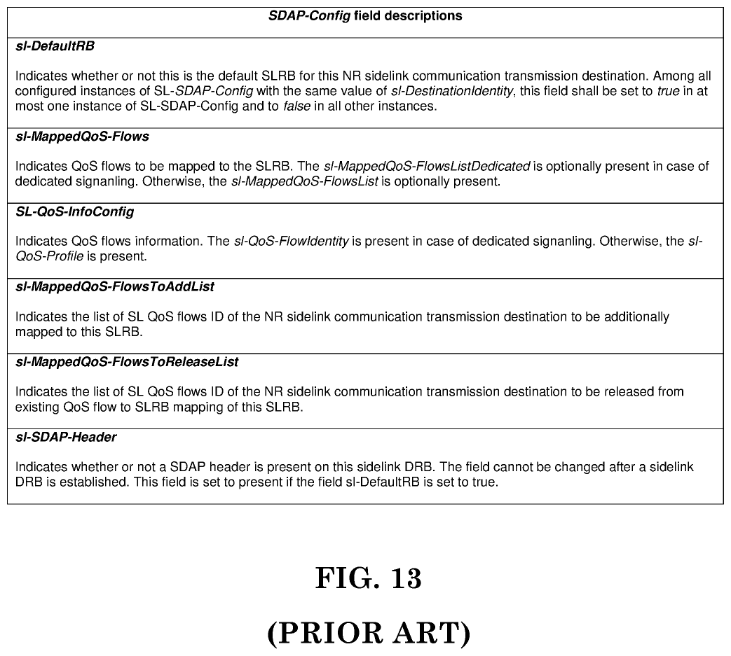

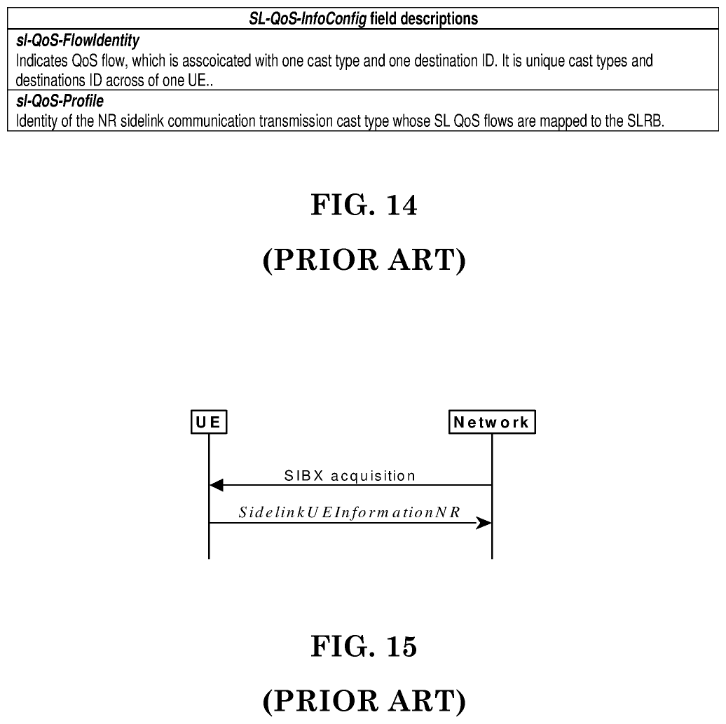

Table entitled “SDAP-Config field descriptions” reproduced as FIG. 13.
Table entitled “SL-QoS-InfoConfig field descriptions” reproduced as FIG. 14.
5.X.3 Sidelink UE information for NR sidelink communication

### 5.X.3.1 General

FIG. 5.X.3.1-1 reproduced as FIG. 15.
The purpose of this procedure is to inform the network that the UE is interested or no longer interested to receive NR sidelink communication, as well as to request assignment or release of transmission resource for NR sidelink communication and to report parameters related to NR sidelink communication.

### 5.x.3.2 Initiation

A UE capable of NR sidelink communication that is in RRC_CONNECTED may initiate the procedure to indicate it is (interested in) receiving NR sidelink communication in several cases including upon successful connection establishment or resuming, upon change of interest, upon change to a PCell providing SIBX including sl-ConfigCommonNR. A UE capable of NR sidelink communication may initiate the procedure to request assignment of dedicated resources for NR sidelink communication transmission.
Upon initiating this procedure, the UE shall:
1> if SIBX including sl-ConfigCommonNR is provided by the PCell:
   2> ensure having a valid version of SIBX for the PCell;
   2> if configured by upper layers to receive NR sidelink communication on the frequency included in sl-FreqInfoList in SIBX of the PCell:
      3> if the UE did not transmit a SidelinkUEInformationNR message since last entering RRC_CONNECTED state; or
      3> if since the last time the UE transmitted a SidelinkUEInformationNR message the UE connected to a PCell not providing SIBX including sl-ConfigCommonNR; or
      3> if the last transmission of the SidelinkUEInformationNR message did not include sl-RxInterestedFreqList; or if the frequency configured by upper layers to receive NR sidelink communication on has changed since the last transmission of the SidelinkUEInformationNR message:
         4> initiate transmission of the SidelinkUEInformationNR message to indicate the NR sidelink communication reception frequency of interest in accordance with 5.x.3.3;
   2> else:
      3> if the last transmission of the SidelinkUEInformationNR message included sl-RxnterestedFreqList:
         4> initiate transmission of the SidelinkUEInformationNR message to indicate it is no longer interested in NR sidelink communication reception in accordance with 5.x.3.3;
   2> if configured by upper layers to transmit NR sidelink communication on the frequency included in sl-FreqInfoList in SIBX of the PCell:
      3> if the UE did not transmit a SidelinkUEInformationNR message since last entering RRC_CONNECTED state; or
      3> if since the last time the UE transmitted a SidelinkUEInformationNR message the UE connected to a PCell not providing SIBX including sl-ConfigCommonNR; or
      3> if the last transmission of the SidelinkUEInformationNR message did not include sl-TxResourceReqList; or if the information carried by the sl-TxResourceReqList has changed since the last transmission of the SidelinkUEInformationNR message:
         4> initiate transmission of the SidelinkUEInformationNR message to indicate the NR sidelink communication transmission resources required by the UE in accordance with 5.X.3.3;
   2> else:
      3> if the last transmission of the SidelinkUEInformationNR message included sl-TxResourceReqList:
         4> initiate transmission of the SidelinkUEInformationNR message to indicate it no longer requires NR sidelink communication transmission resources in accordance with 5.X.3.3.

### 5.x.3.3 Actions Related to Transmission of SidelinkUEInformationNR Message

The UE shall set the contents of the SidelinkUEInformationNR message as follows:
1> if the UE initiates the procedure to indicate it is (no more) interested to receive NR sidelink communication or to request (configuration/release) of NR sidelink communication transmission resources (i.e. UE includes all concerned information, irrespective of what triggered the procedure):
   2> if SIBX including sl-ConfigCommonNR is provided by the PCell:
      3> if configured by upper layers to receive NR sidelink communication:
         4> include sl-RxInterestedFreqList and set it to the frequency for NR sidelink communication reception;
      3> if configured by upper layers to transmit NR sidelink communication:
         4> include sl-TxResourceReqList and set its fields as follows for each destination for which it requests network to assign NR sidelink communication resource:
         5> set sl-DestinationIdentity to the destination identity configured by upper layer for NR sidelink communication transmission;
         5> set sl-CastType to the cast type of the associated destination identity configured by the upper layer for the NR sidelink communication transmission;
         5> set sl-RLC-ModeIndication to include the RLC mode(s) and optionally QoS profile(s) of the sidelink QoS flow(s) of the associated RLC mode(s), if the associated bi-directional sidelink DRB addition is due to the configuration by RRCReconfigurationSidelink;
         5> set sl-Failure for the associated destination for the NR sidelink communication transmission, if the sidelink RLF is detected;
         5> set sl-QoS-InfoList to include QoS profile(s) of the sidelink QoS flow(s) of the associated destination configured by the upper layer for the NR sidelink communication transmission;
         5> set sl-InterestedFreqList to indicate the frequency for NR sidelink communication transmission;
         5> set sl-Type TxSyncList to the current synchronization reference type used on the associated sl-InterestedFreqList for NR sidelink communication transmission.
1> The UE shall submit the SidelinkUEInformationNR message to lower layers for transmission.
   . . . .
SidelinkUEInformationNR
   The SidelinkUEinformationNR message is used for the indication of NR sidelink UE information to the network.
Signalling radio bearer: SRB1
RLC-SAP: AM
Logical channel: DCCH
Direction: UE to Network

SidelinkUEInformationNR message

-- ASN1START
-- TAG-SIDELINKUEINFORMATIONNR-START

| SidelinkUEInformationNR-r16::= | | SEQUENCE { |
|---|---|---|
| | criticalExtensions | CHOICE { |

| | |
|---|---|
| sidelinkUEInformationNR-r16 | SidelinkUEInformationNR-r16-IEs, |
| criticalExtensionsFuture | SEQUENCE { } |

}

}

| | |
|---|---|
| SidelinkUEInformationNR-r16-IEs::= | SEQUENCE { |

| | | |
|---|---|---|
| sl-RxInterestedFreqList-r16 | SL-InterestedFreqList-r16 | OPTIONAL, |
| sl-TxResourceReqList-r16 | SL-TxResourceReqList-r16 | OPTIONAL, |
| lateNonCriticalExtension | OCTET STRING | OPTIONAL, |
| nonCriticalExtension | SEQUENCE { } | OPTIONAL |

}

| | |
|---|---|
| SL-InterestedFreqList-r16 | SEQUENCE (SIZE (1..maxNrofFreqSL-r16)) OF INTEGER |

(1..maxNrofFreqSL-r16)

| | |
|---|---|
| SL-TxResourceReqList-r16 ::= | SEQUENCE (SIZE (1..maxNrofSL-Dest-r16)) OF SL- |

TxResourceReq-r16

| | |
|---|---|
| SL-TxResourceReq-r16::= | SEQUENCE { |

| | |
|---|---|
| sl-DestinationIdentity-r16 | SL-DestinationIdentity-r16, |
| sl-CastType-r16 | ENUMERATED {broadcast, groupcast, unicast, spare1}, |

| | |
|---|---|
| sl-RLC-ModeIndication-r16 | SEQUENCE { |

| | |
|---|---|
| sl-AM-Mode-r16 | SEQUENCE { |

| | |
|---|---|
| sl-AM-Mode-r16 | ENUMERATED {true}, |
| sl-AM-QoS-InfoList-r16 | SEQUENCE (SIZE (1..maxNrofSL-QFIsPerDest-r16)) OF |

| | |
|---|---|
| SL-QoS-Info-r16 | OPTIONAL |

}

OPTIONAL,

| | |
|---|---|
| sl-UM-Mode-r16 | SEQUENCE { |

| | |
|---|---|
| sl-UM-Mode-r16 | ENUMERATED {true}, |
| sl-UM-QoS-InfoList-r16 | SEQUENCE (SIZE (1..maxNrofSL-QFIsPerDest-r16)) OF |

| | |
|---|---|
| SL-QoS-Info-r16 | OPTIONAL |

}

OPTIONAL

}

OPTIONAL,

| | |
|---|---|
| sl-QoS-InfoList-r16 | SEQUENCE (SIZE (1..maxNrofSL-QFIsPerDest-r16)) OF SL- |

| | |
|---|---|
| QoS-Info-r16 | OPTIONAL, |

| | |
|---|---|
| sl-Failure-r16 | ENUMERATED {true} |

OPTIONAL,

| | |
|---|---|
| sl-TypeTxSyncList-r16 | SEQUENCE (SIZE (1..maxNrofFreqSL-r16)) OF SL- |

| | |
|---|---|
| TypeTxSync-r16 | OPTIONAL, |

| | |
|---|---|
| sl-TxInterestedFreqList-r16 | SEQUENCE (SIZE (1..maxNrofFreqSL-r16)) OF INTEGER |

| | |
|---|---|
| (1..maxNrofFreqSL-r16) | OPTIONAL |

}

| | |
|---|---|
| SL-QoS-Info-r16 ::= | SEQUENCE { |

| | |
|---|---|
| sl-QoS-FlowIdentity-r16 | SL-QoS-FlowIdentity-r16, |
| sl-QoS-Profile-r16 | SL-QoS-Profile-r16 |

}
-- TAG-SIDELINKUEINFORMATIONNR-STOP
-- ASN1STOP

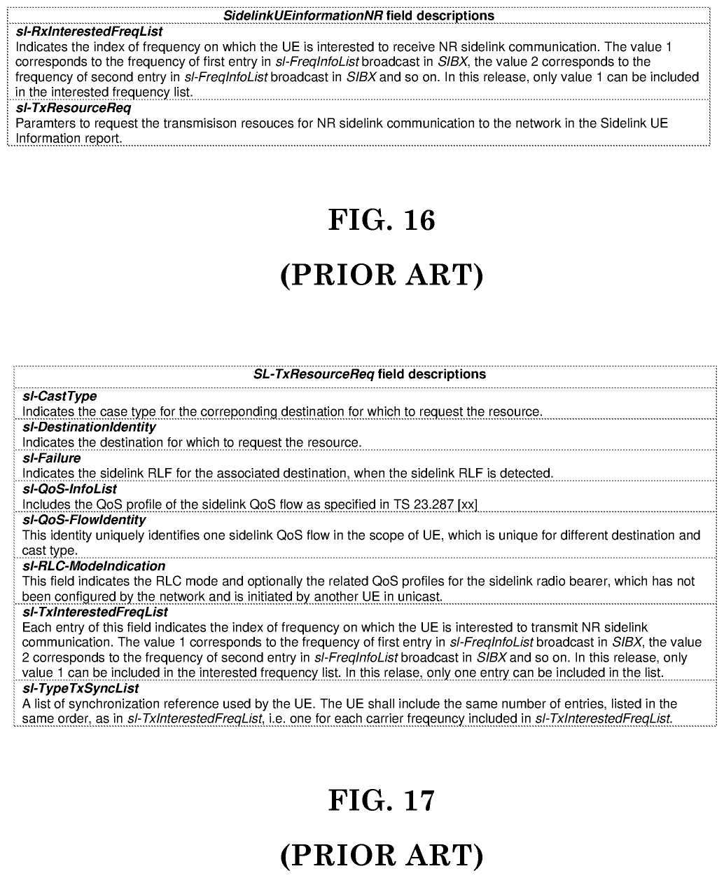

Table entitled “SidelinkUEinformationNR field descriptions” reproduced as FIG. 16.
Table entitled “SL-TxResourceReq field descriptions” reproduced as FIG. 17.
5.X.9 Sidelink RRC procedure
5.X.9.1 Sidelink RRC reconfiguration

### 5.x.9.1.1 General

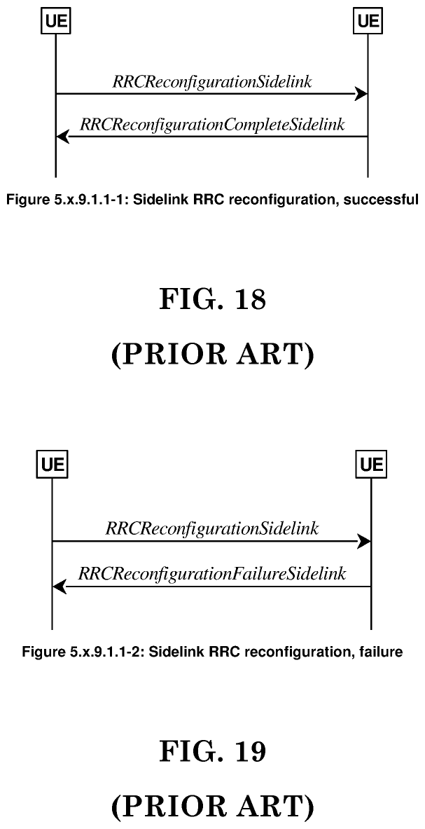

FIG. 5.x.9.1.1-1 reproduced as FIG. 18.
FIG. 5.x.9.1.1-2 reproduced as FIG. 19.
The purpose of this procedure is to establish/modify/release sidelink DRBs or configure NR sidelink measurement and report for a PC5-RRC connection.
The UE may initiate the sidelink RRC reconfiguration procedure and perform the operation in sub-clause 5.x.9.1.2 to its peer UE in following cases:
the release of sidelink DRBs associated with the peer UE, as specified in sub-clause 5.x.9.1.4;
the establishment of sidelink DRBs associated with the peer UE, as specified in sub-clause 5.x.9.1.5;
the modification for the parameters included in SLRB-Config of sidelink DRBs associated with the peer UE, as specified in sub-clause 5.x.9.1.5;
the configuration of the peer UE to perform NR sidelink measurement and report.

### 5.x.9.1.2 Actions Related to Transmission of RRCReconfigurationSidelink Message

The UE shall set the contents of RRCReconfigurationSidelink message as follows:
1> for each sidelink DRB that is to be released, according to sub-clause 5.x.9.1.4.1, due to configuration by sl-ConfigDedicatedNR, SIBX, SidelinkPreconfigNR or by upper layers:
   2> set the slrb-PC5-ConfigIndex included in the slrb-ConfigToReleaseList corresponding to the sidelink DRB;
1> for each sidelink DRB that is to be established or modified, according to sub-clause 5.x.9.1.5.1, due to receiving sl-ConfigDedicatedNR, SIBX, SidelinkPreconfigNR:
   2> set the SLRB-Config included in the slrb-ConfigToAddModList, according to the received sl-RadioBearerConfig and sl-RLC-BearerConfig corresponding to the sidelink DRB;
1> for each NR sidelink measurement and report that is to be configured:
   2> set the sl-MeasConfig according to the stored NR sidelink measurement configuration information;
1> start timer T400 for the destination associated with the sidelink DRB;
   The UE shall submit the RRCReconfigurationSidelink message to lower layers for transmission.

### 5.x.9.1.3 Reception of an RRCReconfigurationSidelink by the UE

The UE shall perform the following actions upon reception of the RRCReconfigurationSidelink:
1> if the RRCReconfigurationSidelink includes the slrb-ConfigToReleaseList:
   2> for each slrb-PC5-ConfigIndex value included in the slrb-ConfigToReleaseList that is part of the current UE sidelink configuration;
      3> perform the sidelink DRB release procedure, according to sub-clause 5.x.9.1.4;
1> if the RRCReconfigurationSidelink includes the slrb-ConfigToAddModList:
   2> for each sirb-PC5-ConfigIndex value included in the sirb-ConfigToAddModList that is not part of the current UE sidelink configuration:
      3> apply the sl-MappedQoS-FlowsToAddList and sl-MappedQoS-FlowsToReleaseList, if included;
      3> perform the sidelink DRB addition procedure, according to sub-clause 5.x.9.1.5;
   2> for each slrb-PC5-ConfigIndex value included in the slrb-ConfigToAddModList that is part of the current UE sidelink configuration:
      3> apply the sl-MappedQoS-FlowsToAddList and sl-MappedQoS-FlowsToReleaseList, if included;
      3> perform the sidelink DRB release or modification procedure, according to sub-clause 5.x.9.1.4 and 5.x.9.1.5.
1> if the UE is unable to comply with (part of) the configuration included in the RRCReconfigurationFailureSidelink (i.e. sidelink RRC reconfiguration failure):
   2> continue using the configuration used prior to the reception of RRCReconfigurationFailureSidelink message;
   2> set the content of the RRCReconfigurationFailureSidelink message;
      3> submit the RRCReconfigurationFailureSidelink message to lower layers for transmission;
1> else:
   2> set the content of the RRCReconfigurationCompleteSidelink message;
      3> submit the RRCReconfigurationCompleteSidelink message to lower layers for transmission; NOTE X: When the same logincal channel is configured with different RLC mode by another UE, the UE handles the case as sidelink RRC reconfiguration failure.
         . . . .
RRCReconfigurationSidelink
   The RRCReconfigurationSidelink message is the command to AS configuration of the PC5 RRC connection. It is only applied to unicast of NR sidelink communication.
Signalling radio bearer: Sidelink SRB for PC5-RRC
RLC-SAP: AM
Logical channel: SCCH
Direction: UE to UE

-- ASN1START
-- TAG-RRCRECONFIGURATIONSIDELINK-START

| | |
|---|---|
| RRCReconfigurationSidelink ::= | SEQUENCE { |

| | |
|---|---|
| rrc-TransactionIdentifier-r16 | RRC-TransactionIdentifier, |
| criticalExtensions | CHOICE { |

| | |
|---|---|
| rrcReconfigurationSidelink-r16 | RRCReconfigurationSidelink-IEs-r16, |
| criticalExtensionsFuture | SEQUENCE { } |

}

}

| | |
|---|---|
| RRCReconfigurationSidelink-IEs-r16 ::= | SEQUENCE { |

| | |
|---|---|
| slrb-ConfigToAddModList-r16 | SEQUENCE (SIZE (1..maxNrofSLRB-r16)) OF SLRB- |

| | |
|---|---|
| Config-r16 | OPTIONAL, |

| | |
|---|---|
| slrb-ConfigToReleaseList-r16 | SEQUENCE (SIZE (1..maxNrofSLRB-r16)) OF SLRB- |

| | |
|---|---|
| PC5-ConfigIndex-r16 | OPTIONAL, |

| | |
|---|---|
| sl-MeasConfig-r16 | SL-MeasConfig-r16 |

OPTIONAL,

| | |
|---|---|
| sl-CSI-Config-r16 | SL-CSI-Config-r16 |

OPTIONAL,

| | |
|---|---|
| lateNonCriticalExtension | OCTET STRING |

OPTIONAL,

| | |
|---|---|
| nonCriticalExtension | SEQUENCE { } |

OPTIONAL
}

| | |
|---|---|
| SLRB-Config-r16::= | SEQUENCE { |

| | |
|---|---|
| slrb-PC5-ConfigIndex-r16 | SLRB-PC5-ConfigIndex-r16, |
| sl-SDAP-Config-r16 | SL-SDAP-Config-r16 |

OPTIONAL, -- Need N

| | |
|---|---|
| sl-PDCP-Config-r16 | SL-PDCP-Config-r16 |

OPTIONAL, -- Need N

| | |
|---|---|
| sl-RLC-Config-r16 | SL-RLC-Config-r16 |

OPTIONAL, -- Need N

| | |
|---|---|
| sl-MAC-LogicalChannelConfig-r16 | SL-LogicalChannelConfig-r16 |

OPTIONAL, -- Need N

...

}

| | |
|---|---|
| SLRB-PC5-ConfigIndex-r16 ::= | INTEGER (1..maxNrofSLRB-r16) |

| | |
|---|---|
| SL-SDAP-Config-r16 ::= | SEQUENCE { |

| | |
|---|---|
| sl-MappedQoS-FlowsToAddList-r16 | SEQUENCE (SIZE (1..maxNrofSL-QFIs-r16)) OF SL- |

| | |
|---|---|
| PFI-r16 | OPTIONAL, -- Need N |

| | |
|---|---|
| sl-MappedQoS-FlowsToReleaseList-16 | SEQUENCE (SIZE (1..maxNrofSL-QFIs-r16)) OF SL- |

| | |
|---|---|
| PFI-r16 | OPTIONAL, -- Need N |

...

}
-- Editor's note: double check if it is OK to use the same filed name with the one in NR-RRC-
Definitions.

| | |
|---|---|
| SL-PDCP-Config-r16 ::= | SEQUENCE { |

| | |
|---|---|
| sl-PDCP-SN-Size-r16 | ENUMERATED {len12bits, len18bits} |

OPTIONAL, -- Need N

| | |
|---|---|
| sl-HeaderCompression-r16 | CHOICE { |

| | |
|---|---|
| notUsed-r16 | NULL, |
| rohc-r16 | SEQUENCE { |
| maxCID-r16 | INTEGER (1..16383) |

DEFAULT 15

}

},
...

}

| | |
|---|---|
| SL-RLC-Config-r16 ::= | CHOICE { |

| | |
|---|---|
| sl-AM-RLC-r16 | SEQUENCE { |

| | |
|---|---|
| sl-SN-FieldLengthAM-r16 | SN-FieldLengthAM |

| | |
|---|---|
| OPTIONAL, | -- Need M |

| ... | |
|---|---|
| }, | |
| sl-UM-Bi-Directional-RLC-r16 | SEQUENCE { |

| | |
|---|---|
| sl-SN-FieldLengthUM-r16 | SN-FieldLengthUM |

| | |
|---|---|
| OPTIONAL, | -- Need M |

| ... | |
|---|---|
| }, | |
| sl-UM-Uni-Directional-RLC-r16 | SEQUENCE { |

| | |
|---|---|
| sl-SN-FieldLengthUM-r16 | SN-FieldLengthUM |

| | |
|---|---|
| OPTIONAL, | -- Need M |

...
}

}

| | |
|---|---|
| SL-LogicalChannelConfig-r16 ::= | SEQUENCE { |

| | |
|---|---|
| sl-LogicalChannelIdentity-r16 | LogicalChannelIdentity, |

...

}

| | |
|---|---|
| SL-PFI-r16 ::= | INTEGER (1..64) |

| | |
|---|---|
| SL-CSI-RS-Config-r16 ::= | SEQUENCE { |

| | |
|---|---|
| sl-CSI-RS-FreqAllocation-r16 | CHOICE { |

| | |
|---|---|
| sl-OneAntennaPort-r16 | BIT STRING (SIZE (12)), |
| sl-TwoAntennaPort-r16 | BIT STRING (SIZE (6)) |

}

OPTIONAL, -- Need N

| | |
|---|---|
| sl-CSI-RS-FirstSymbol-r16 | INTEGER (FFS) |

OPTIONAL, -- Need N

...

}
-- TAG-RRCRECONFIGURATIONSIDELINK-STOP
-- ASN1STOP

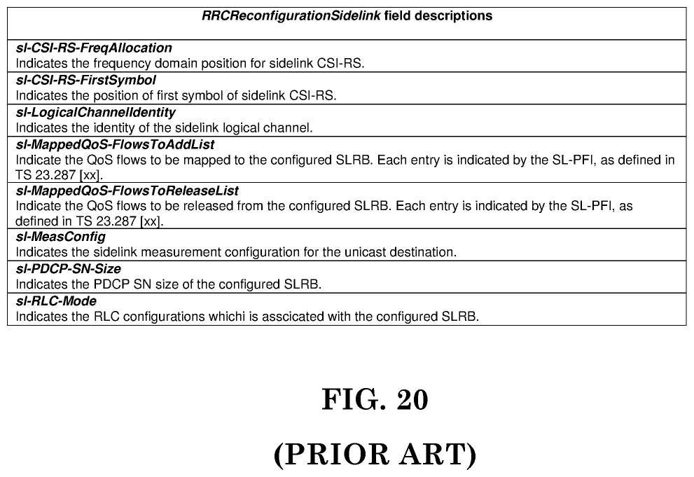

Table entitled “RRCReconfigurationSidelink field descriptions” reproduced as FIG. 20. RRCReconfigurationCompleteSidelink
The RRCReconfigurationCompleteSidelink message is used to confirm the successful completion of a PC5 RRC AS reconfiguration. It is only applied to unicast of NR sidelink communication.
Signalling radio bearer: Sidelink SRB for PC5-RRC
RLC-SAP: AM
Logical channel: SCCH
Direction: UE to UE

RRCReconfigurationCompleteSidelink message

-- ASN1START
-- TAG-RRCRECONFIGURATIONCOMPLETESIDELINK-START

| | |
|---|---|
| RRCReconfigurationCompleteSidelink ::= | SEQUENCE { |

| | |
|---|---|
| rrc-TransactionIdentifier-r16 | RRC-TransactionIdentifier, |
| criticalExtensions | CHOICE { |

| | |
|---|---|
| rrcReconfigurationCompleteSidelink-r16 | RRCReconfigurationCompleteSidelink-IEs- |

r16,

| | |
|---|---|
| criticalExtensionsFuture | SEQUENCE { } |

}

}

| | |
|---|---|
| RRCReconfigurationCompleteSidelink-IEs-r16 ::= | SEQUENCE { |

-- FFS on the details

| | |
|---|---|
| lateNonCriticalExtension | OCTET STRING |

OPTIONAL,

| | |
|---|---|
| nonCriticalExtension | SEQUENCE { } |

OPTIONAL
}
-- TAG-RRCRECONFIGURATIONCOMPLETESIDELINK-STOP
-- ASN1STOP

3GPP TS23.287 specifies a layer-2 link establishment procedure for unicast mode of V2X communication over PC5 reference point in section 6.3.3.1. For example, the initiating UE (e.g. UE1) transmits a Direct Communication Request message and receives a Direct Communication Accept message from other UE(s). According to section 5.6.1.4 in 3GPP TS23.287, the initial signalling for the establishment of the PC5 unicast link may use a default destination Layer-2 ID for initial signalling to establish a unicast link for a Vehicle-to-Everything (V2X) service or a V2X application which offers the V2X service (e.g. Provider Service Identifiers (PSIDs) or ITS Application Identifiers (ITS-AIDs)).

In the Direct Communication Request message, UE2's application layer ID and UE1's application layer ID are included so that UE2 can determine whether to respond to the Direct Communication Request message. If UE2 determines to respond to the Direct Communication Request message, UE2 may initiate the procedure used to establish security context. For example, UE1 transmits a Direct Communication Request to UE2. In the Direct Communication Request, some parameters used to establish security context could be included. Upon reception of the Direct Communication Request, UE2 may initiate a Direct Auth and Key Establish procedure with UE1. And then, UE2 transmits a Direct Security Mode Command to UE1, and UE1 responds to UE2 with a Direct Security Mode Complete. In addition, if the Direct Security Mode Complete is received successfully, UE2 may transmit a Direct Communication Accept to UE1. In case security is not needed for the unicast link, the security configuration procedure can be omitted and UE2 may reply the Direct Communication Accept to UE 1 directly.

When the Direct Communication Request message is transmitted, the source Layer-2 ID is set to Layer-2 ID of the initiating UE and the destination Layer-2 ID is set to the default destination Layer-2 ID associated with the service type. Therefore, UE2 may start to exchange signalling in the security establishment procedure based on the Layer-2 Identity (L2ID) of UE1 and a L2ID of UE2.

According to 3GPP TR 38.885-g00 and the 3GPP email discussion [108#44][V2X] 38.331 running CR, a UE in RRC_CONNECTED will need to send a Sidelink UE Information message (e.g., SidelinkUEInformationNR) to a next generation Node B (gNB) to request sidelink resources for transmitting sidelink traffic after a layer-2 link (or unicast link) has been established. gNB will then provide a dedicated sidelink configuration information (e.g., Information Element (IE) SL-ConfigDedicatedNR) for New RAT/Radio (NR) sidelink communication.

As specified in 3GPP email discussion [108#44][V2X] 38.331 running CR, SidelinkUEInformationNR may include the following information elements (IEs) related to the unicast link: sl-DestinationIdentity, sl-CastType, sl-RLC_ModeIndication, sl-QoS-InfoList, sl-Failure, sl-TypeTxSyncList, and sl-TxInterestedFreqList. And, sl-QoS-InfoList contains a list of sl-QoS-Info, which is specified in 3GPP TS 23.287 to include the Quality of Service (QoS) profile of a sidelink QoS flow, and each sl-QoS-Info includes a sl-QoS-Flowdentity and sl-QoS-Profile. In response to reception of the SidelinkUEInformationNR, gNB may reply with a Radio Resource Control (RRC) Reconfiguration message (e.g., RRCReconfiguration) to configure the dedicated sidelink configuration for the concerned sidelink QoS flow(s) identified by sl-QoS-FlowIdentity. For example, [symbol] RRCReconfiguration message may include IE SL-ConfigDedicatedNR, which may contain information to indicate the dedicated sidelink configuration. It may also contain information to indicate to which Sidelink (SL) Data Radio Bearer (DRB) a sidelink QoS flow is mapped (e.g., sl-MappedQoS-Flows). The sidelink QoS flow may be mapped to an existing SL DRB or a new SL DRB. In the event a new SL DRB is needed, a logical channel configuration will be included for the new SL DRB. It is noted that each SL DRB is associated with a SL LCH (Logical Channel).

As agreed in RAN2#106 meeting for 3GPP R2-1908107, for SL unicast, the initiating UE informs the peer UE of the Sidelink Radio Bearer (SLRB) parameters that are related to both Transmission (TX) and Reception (RX) and need to be aligned with the peer UE. For example, the initiating UE may transmit a RRCReconfigurationSidelink message to inform the peer UE as discussed in the 3GPP email discussion [108#44][V2X] 38.331 running CR, wherein slrb-PC5-ConfigIndex is included in the RRCReconfigurationSidelink to indicate the SLRB configuration for a SLRB to be established in the peer UE. In response, the peer UE may reply with a RRCReconfigurationCompleteSidelink message. In addition, according to RAN2#108 agreement for 3GPP R2-1916288, the peer UE shall report at least the Radio Link Control (RLC) mode indicated by the initiating UE to its gNB when the peer UE in RRC_CONNECTED receives an SLRB configuration with RLC Acknowledged Mode/Unacknowledged Mode (AM/UM) from the initiating UE and if the LCH has not been configured in the peer UE. It was also agreed that sidelink QoS profile is optional to be reported. The previous agreements were captured in the 3GPP email discussion [108#44][V2X] 38.331 running CR, where the IE sl-QoS-InfoList defined in the SidelinkUEInformationNR message is specified as “Optional” and both sl-QoS-FlowIdentity and sl-QoS-Profile in IE sl-QoS-Info are specified as “Mandatory.” If sl-QoS-Info corresponding to a sidelink QoS flow is present, it means the peer UE has data available for transmission from the sidelink QoS flow identified by sl-QoS-FlowIdentity in the sl-QoS-Info. Otherwise, (i.e., sl-QoS-Info is absent), it means the peer UE has no data available for transmission from the sidelink QoS flow. The latter case implies that the peer UE only has RLC Control Packet Data Unit (PDU) (for RLC AM mode) or Packet Data Convergence Protocol (PDCP) Control PDU (for Robust Header Compression (ROHC) feedback) and thus there is no need include sl-QoS-InfoList. After receiving the SidelinkUEInformationNR message, gNB may then allocate a proper dedicated sidelink configuration to the peer UE according to whether sl-QoS-Info is present.

It is specified in the 3GPP email discussion [108#44][V2X] 38.331 running CR that the peer UE shall submit either a RRCReconfigurationCompleteSidelink message or a RRCReconfigurationFailureSidelink message to the lower layers for transmission upon reception of the RRCReconfigurationSidelink message from the UE depending on whether the peer UE is able to comply with (part of) the configuration included in the RRCReconfigurationSidelink message. The RRCReconfigurationFailureSidelink message is submitted for transmission if the peer UE is unable to comply with (part of) the configuration included in the RRCReconfigurationSidelink message. Otherwise, the RRCReconfigurationCompleteSidelink message is submitted for transmission. Basically, the RRCReconfigurationSidelink message is used to provide the SLRB configuration for transmission from the UE to the peer UE on a SLRB (or SL LCH). And, the peer UE then needs to request the corresponding SLRB configuration for transmission from the peer UE to the UE for a sidelink QoS flow via the SidelinkUEInformationNR message sent to its gNB. Basically, the availability of bi-directional sidelink communication between the UE and the peer UE depends on not only the SLRB configuration provided in the RRCReconfigurationSidelink message, but also the corresponding SLRB configuration provided in the RRCReconfiguration message sent from the gNB. In case the peer UE is unable to comply with (or a part of) the corresponding SLRB configuration provided in the RRCReconfiguration message sent from the gNB, the sidelink transmission from the peer UE to the UE for the concerned sidelink QoS flow cannot be performed. As a result, the bi-directional sidelink communication between the UE and the peer UE will be unavailable. In this situation, the UE behaviors in response to this failure case should be specified.

One or more than one of the following actions may be taken by the peer UE: (1) the peer UE releases the SL DRB to which the concerned sidelink QoS flow is mapped for a sidelink transmission from the UE to the peer UE, wherein the SL DRB has been established in the peer UE according to a RRCReconfigurationSidelink message received from the UE; (2) the peer UE releases all SL DRBs established for the concerned destination (or the concerned PC5 unicast link); (3) the peer UE indicates release of the concerned PC5-RRC connection (or the concerned PC5 unicast link) to the upper layers for the concerned destination; (4) the peer UE transmits a PC5-RRC message (e.g., RRCReconfigurationSidelink) to the UE to release the concerned sidelink QoS flow or the SL DRB to which the concerned sidelink QoS flow is mapped for a sidelink transmission from the UE to the peer UE; (5) the peer UE indicates a failure (e.g., Access Stratum (AS) layer fails to configure a SL DRB for the concerned sidelink QoS flow) to the upper layers; and/or (6) the peer UE transmits a RRC message to the gNB to indicates the failure.

Being informed of the failure, the upper layers of the peer UE may then take one or more than one of the following actions: (1) the upper layers remove or release the concerned sidelink QoS flow; (2) the upper layers remove or release the V2X service associated with the concerned sidelink QoS flow; and/or (3) the upper layers release the PC5 unicast link established between the UE and the peer UE.

The upper layers of the peer UE and the upper layers of the UE may exchange PC5-S signalling to remove or release the concerned sidelink QoS flow, the V2X serviced associated with the concerned sidelink QoS flow and/or the PC5 unicast link established between the UE and the peer UE.

On the other hand, a similar failure may also occur when the UE requests a SLRB configuration for a sidelink QoS flow for transmission from the UE to the peer UE and receives a RRCReconfiguration message from gNB. In this situation, no SL DRB has been established in the UE for the concerned sidelink QoS flow yet. The UE and the upper layers in the UE may also take one or more than one of the above actions (if applicable) in response to this failure.

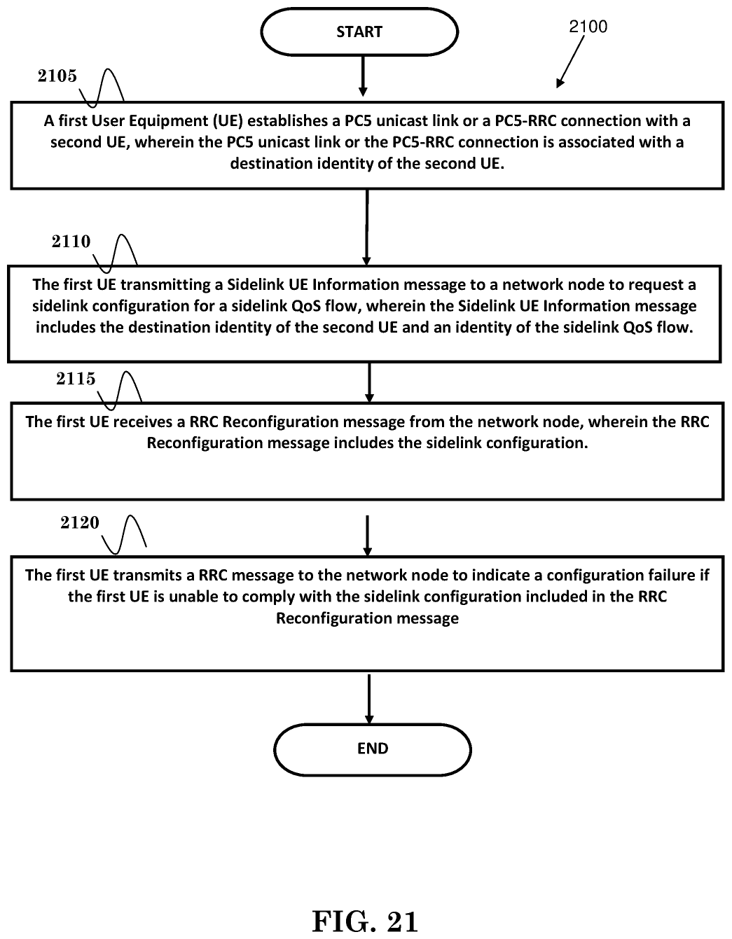

FIG. 21 is a flow chart 2100 according to one exemplary method from the perspective of a first device such as, but not limited to, a UE. In step 2105, a first UE establishes a PC5 unicast link or a PC5-RRC connection with a second UE, wherein the PC5 unicast link or the PC5-RRC connection is associated with a destination identity of the second UE. In step 2110, the first UE transmits a Sidelink UE Information message to a network node to request a sidelink configuration for a sidelink Quality of Service (QoS) flow, wherein the Sidelink UE Information message includes the destination identity of the second UE and an identity of the sidelink QoS flow. In step 2115, the first UE receives a Radio Resource Control (RRC) Reconfiguration message from the network node, wherein the RRC Reconfiguration message includes the sidelink configuration. In step 2120, the first UE transmits a RRC message to the network node to indicate a configuration failure if the first UE is unable to comply with the sidelink configuration included in the RRC Reconfiguration message.

In another method, the first UE releases a first Sidelink (SL) Data Radio Bearer (DRB) to which the sidelink QoS flow is mapped if the first SL DRB has been established, wherein the first SL DRB is established for sidelink transmissions from the second UE to the first UE.

In another method, a failure is indicated to the upper layers in the first UE.

In another method, the Sidelink UE Information message furthers includes a QoS profile of the sidelink QoS flow.

In another method, the sidelink configuration includes a Sidelink Radio Bearer (SLRB) configuration for a second SL DRB to which the sidelink QoS flow is mapped for transmissions from the first UE to the second UE.

In another method, the upper layers in the first UE release the sidelink QoS flow.

In another method, the upper layers in the first UE release or remove a Vehicle-to-Everything (V2X) service associated with the sidelink QoS flow.

In another method, the upper layers in the first UE release the PC5 unicast link.

In another method, the network node is a base station or a gNB.

In another method, the first UE transmits a PC5-RRC message to the second UE if the first UE is unable to comply with at least a portion of the sidelink configuration included in the RRC Reconfiguration message, wherein the PC5-RRC message includes an identity of the first SL DRB or an identity of the sidelink QoS flow for release.

Referring back to FIGS. 3 and 4, in one embodiment, the device 300 includes a program code 312 stored in memory 310. The CPU 308 could execute program code 312 to (i) establish a PC5 unicast link or a PC5-RRC connection with a second UE, wherein the PC5 unicast link or the PC5-RRC connection is associated with a destination identity of the second UE; (ii) transmit a Sidelink UE Information message to a network node to request a sidelink configuration for a sidelink Quality of Service (QoS) flow, wherein the Sidelink UE Information message includes the destination identity of the second UE and an identity of the sidelink QoS flow; (iii) receive a Radio Resource Control (RRC) Reconfiguration message from the network node, wherein the RRC Reconfiguration message includes the sidelink configuration; and (iv) transmit a RRC message to the network node to indicate a configuration failure if the first UE is unable to comply with the sidelink configuration included in the RRC Reconfiguration message.

Furthermore, the CPU 308 can execute the program code 312 to perform all of the above-described actions and steps or others methods described herein.

The above-disclosed methods are methods for handling an invalid RRCReconfiguration message.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a first User Equipment (UE) to handle an invalid Radio Resource Control (RRC) reconfiguration message, the method comprising:
establishing a PC5 unicast link or a PC5-RRC connection with a second UE, wherein the PC5 unicast link or the PC5-RRC connection is associated with a destination identity of the second UE;
transmitting a Sidelink UE Information message to a network node to request a sidelink configuration for a sidelink Quality of Service (QoS) flow, wherein the Sidelink UE Information message includes the destination identity of the second UE and an identity of the sidelink QoS flow;
receiving a Radio Resource Control (RRC) Reconfiguration message from the network node, wherein the RRC Reconfiguration message includes the sidelink configuration; and
transmitting a RRC message to the network node to indicate a configuration failure if the first UE is unable to comply with the sidelink configuration included in the RRC Reconfiguration message.

2. The method of claim 1, further comprising:
releasing a first Sidelink (SL) Data Radio Bearer (DRB) to which the sidelink QoS flow is mapped if the first SL DRB has been established, wherein the first SL DRB is established for sidelink transmissions from the second UE to the first UE.

3. The method of claim 1, further comprising:
indicating a failure to the upper layers in the first UE.

4. The method of claim 1, wherein the Sidelink UE Information message furthers includes a QoS profile of the sidelink QoS flow.

5. The method of claim 1, wherein the sidelink configuration includes a Sidelink Radio Bearer (SLRB) configuration for a second SL DRB to which the sidelink QoS flow is mapped for transmissions from the first UE to the second UE.

6. The method of claim 3, wherein the upper layers in the first UE release the sidelink QoS flow.

7. The method of claim 3, wherein the upper layers in the first UE release or remove a Vehicle-to-Everything (V2X) service associated with the sidelink QoS flow.

8. The method of claim 3, wherein the upper layers in the first UE release the PC5 unicast link.

9. The method of claim 1, wherein the network node is a base station.

10. The method of claim 1, further comprising:
transmitting a PC5-RRC message to the second UE if the first UE is unable to comply with at least a portion of the sidelink configuration included in the RRC Reconfiguration message, wherein the PC5-RRC message includes an identity of the first SL DRB or an identity of the sidelink QoS flow for release.

11. A first UE (User Equipment), comprising:
a control circuit;
a processor installed in the control circuit; and
a memory installed in the control circuit and operatively coupled to the processor;
wherein the processor is configured to execute a program code stored in the memory to:
establish a PC5 unicast link or a PC5-RRC connection with a second UE, wherein the PC5 unicast link or the PC5-RRC connection is associated with a destination identity of the second UE;
transmit a Sidelink UE Information message to a network node to request a sidelink configuration for a sidelink Quality of Service (QoS) flow, wherein the Sidelink UE Information message includes the destination identity of the second UE and an identity of the sidelink QoS flow;
receive a Radio Resource Control (RRC) Reconfiguration message from the network node, wherein the RRC Reconfiguration message includes the sidelink configuration; and
transmit a RRC message to the network node to indicate a configuration failure if the first UE is unable to comply with the sidelink configuration included in the RRC Reconfiguration message.

12. The first UE of claim 11, wherein the processor is further configured to execute a program code stored in the memory to:
release a first Sidelink (SL) Data Radio Bearer (DRB) to which the sidelink QoS flow is mapped if the first SL DRB has been established, wherein the first SL DRB is established for sidelink transmissions from the second UE to the first UE.

13. The first UE of claim 11, wherein the processor is further configured to execute a program code stored in the memory to:
indicate a failure to the upper layers in the first UE.

14. The first UE of claim 11, wherein the Sidelink UE Information message further includes a QoS profile of the sidelink QoS flow.

15. The first UE of claim 11, wherein the sidelink configuration includes a SLRB configuration for a second SL DRB to which the sidelink QoS flow is mapped for transmission from the first UE to the second UE.

16. The first UE of claim 13, wherein the upper layers in the first UE release the sidelink QoS flow.

17. The first UE of claim 13, wherein the upper layers in the first UE release or remove a V2X service associated with the sidelink QoS flow.

18. The first UE of claim 13, wherein the upper layers in the first UE release the PC5 unicast link.

19. The first UE of claim 11, wherein the network node is a base station.

20. The first UE of claim 11, wherein the processor is further configured to execute a program code stored in the memory to:
transmit a PC5-RRC message to the second UE if the first UE is unable to comply with at least a portion of the sidelink configuration included in the RRC Reconfiguration message, wherein the PC5-RRC message includes an identity of the first SL DRB or an identity of the sidelink QoS flow for release.
